(19) United States
(12) Patent Application Publication
(10) Pub. No.: US 2026/0361356 A1
(43) Pub. Date: Nov. 12, 2026

(54) RE-USE OF MULTI-USER SOUNDING IN WIRELESS BEAMFORMING SYSTEMS

(71) Applicant: SAMSUNG ELECTRONICS CO., LTD., SUWON-SI (KR)

(72) Inventors: AIGUO YAN, SAN JOSE, CA (US); ZIGUI YANG, SAN JOSE, CA (US); SRINIVAS KANDALA, MORGAN HILL, CA (US)

(21) Appl. No.: 19/634,730

(22) Filed: Mar. 31, 2026

Related U.S. Application Data
(60) Provisional application No. 63/800,538, filed on May 6, 2025.

(51) Int. Cl. H04B 7/06; H04W 72/20

(52) U.S. Cl. CPC H04B 7/0617; H04W 72/20

(57) ABSTRACT

A method for performing a beamforming protocol is disclosed in which a single access point transmits a sounding control frame to a station and receives, at the single access point and based on one or more sounding capabilities of the station, a sounding result in a multi-user format from the station.

### CROSS-REFERENCE TO RELATED APPLICATION

This application claims the priority benefit under 35 U.S.C. § 119(e) of U.S. Provisional Application No. 63/800,538, filed on May 6, 2025, the disclosure of which is incorporated by reference in its entirety as if fully set forth herein.

### TECHNICAL FIELD

The disclosure generally relates to wireless communication systems and beamforming operations in multi-antenna networks, including techniques for obtaining multi-user formatted channel state information and enabling re-use of such information in wireless beamforming systems implemented in accordance with the Institute of Electrical and Electronics Engineers (IEEE) 802.11 wireless local area network (WLAN) specification, to improve performance, flexibility, and operational efficiency.

### SUMMARY

In an embodiment, a method for performing a beamforming protocol comprises transmitting, from a single access point, a sounding control frame to a station; and receiving, at the single access point and based on one or more sounding capabilities of the station, a sounding result in a multi-user format from the station.

In another embodiment, a method for performing a beamforming protocol comprises generating, by at least one access point of a plurality of access points, a multi-user sounding control frame identifying a first station and a second station; transmitting, by the at least one access point, the multi-user sounding control frame to the first station; and receiving, by the at least one access point, a sounding result in a multi-user format from the first station.

In a further embodiment, a method for performing a beamforming protocol comprises identifying, by at least one access point of a plurality of access points, a station to receive a multi-user sounding control frame; transmitting, by the at least one access point, the multi-user sounding control frame to the station; and receiving, by the at least one access point, a sounding result in a multi-user format from the station.

### BRIEF DESCRIPTION OF THE DRAWING

In the following section, the aspects of the subject matter disclosed herein will be described with reference to exemplary embodiments illustrated in the figures, in which:

FIG. 1 is a block diagram of an example electronic device configured to perform one or more beamforming and sounding operations according to embodiments of the present disclosure.

FIG. 2A illustrates an example wireless communication environment according to embodiments of the present disclosure.

FIG. 2B illustrates an example beamforming system according to embodiments of the present disclosure.

FIG. 3 sets forth a flowchart illustrating an example method for performing a beamforming protocol according to embodiments of the present disclosure.

FIG. 4 sets forth a flowchart illustrating an example method for generating a null data packet announcement (NDPA) frame comprising an indicator requesting a multi-user formatted sounding response, transmitting a sounding control frame comprising the NDPA frame, transmitting an associated null data packet (NDP), and causing generation of the multi-user formatted sounding response according to embodiments of the present disclosure.

FIG. 5 sets forth a flowchart illustrating re-use of a multi-user formatted sounding result in a multi-user beamforming protocol according to embodiments of the present disclosure.

FIG. 6 sets forth a flowchart illustrating re-use of a multi-user formatted sounding result in a coordinated beamforming protocol according to embodiments of the present disclosure.

FIG. 7A illustrates another example wireless communication environment according to embodiments of the present disclosure.

FIG. 7B illustrates another example beamforming system according to embodiments of the present disclosure.

FIG. 8 sets forth another flowchart illustrating an example method for performing a beamforming protocol according to embodiments of the present disclosure.

FIG. 9 sets forth a flowchart illustrating identification of a station designated to satisfy a multi-user NDPA frame structure, transmission of a multi-user sounding control frame comprising a multi-user NDPA frame, transmission of an associated NDP, causing generation of a multi-user formatted sounding response, and receipt of the multi-user formatted sounding response according to embodiments of the present disclosure.

FIG. 10A illustrates a further example wireless communication environment according to embodiments of the present disclosure.

FIG. 10B illustrates a further example beamforming system according to embodiments of the present disclosure.

FIG. 11 sets forth a further flowchart illustrating an example method for performing a beamforming protocol according to embodiments of the present disclosure.

FIG. 12 sets forth a flowchart illustrating transmission of a multi-user NDPA frame and associated NDP to a station according to embodiments of the present disclosure.

FIG. 13 illustrates an example cloud-based computing environment in which one or more aspects of the disclosed beamforming techniques may be implemented according to embodiments of the present disclosure.

### DETAILED DESCRIPTION

Technology related to wireless beamforming in WLAN systems may enable efficient spatial multiplexing and interference management in high throughput communication environments. These wireless systems may typically rely on sounding procedures to obtain channel state information from one or more stations so that an access point can perform pre-coding and spatial stream allocation. Conventional implementations may employ distinct signaling formats for single-user and multi-user sounding that can support different feedback parameters and transmission modes. As network deployments evolve toward coordinated beamforming and multi-access point operation, these format distinctions and signaling constraints may limit flexibility in managing channel state information across different beamforming configurations.

To solve this problem, conventional approaches may rely on single-user sounding when only one station participates in a transmission exchange or may attempt to structure multi-user sounding procedures around scenarios involving multiple active stations.

Other efforts may focus on repeating sounding exchanges when transitioning between single-user and multi-user beamforming modes; however, channel state information format is determined by parameters in a sounding control frame, such that repeated sounding produces the same format. Consequently, multi-user formatted feedback is not generated in single-station scenarios, and workarounds that identify an additional station to enable multi-user signaling may introduce additional signaling exchanges, thereby increasing overhead.

One issue with the above approaches is that single-user formatted channel state information lacks feedback elements required for multi-user beamforming, including per-subcarrier metrics, and therefore cannot be directly utilized in multi-user or coordinated beamforming procedures while still requiring additional signaling to satisfy multi-user format requirements. Although multi-user formatted channel state information may be utilized in both single-user and multi-user beamforming modes, conventional sounding procedures do not provide mechanisms for obtaining multi-user formatted channel state information in scenarios involving a single active station. The resulting overhead, latency, and operational complexity can reduce throughput and limit the effectiveness of coordinated beamforming in deployments involving a small number of active stations. These constraints can restrict scalability of advanced beamforming techniques and reduce overall spectral efficiency in next-generation WLAN systems.

To overcome these issues, systems and methods are described herein for performing multi-user sounding procedures that enable an access point to obtain multi-user formatted channel state information from a station. The disclosed techniques may permit generation and transmission of a multi-user NDPA frame identifying one or more stations, including scenarios in which only a single station participates in the sounding exchange. The access point may receive channel state information in a multi-user format that includes feedback parameters suitable for multi-user and coordinated beamforming operations. Selection of signaling parameters, frame formats, and feedback configurations may be guided by design considerations related to compatibility with existing IEEE 802.11 WLAN signaling semantics and desired beamforming performance. The combination of these signaling mechanisms can be tailored to support re-use of sounding results across beamforming modes, reduce signaling overhead, and improve flexibility in deployments involving a limited number of active stations.

The above approaches may improve upon conventional signaling techniques because enabling multi-user sounding with a station can provide access to multi-user formatted channel state information without extra frame exchanges or reliance on multiple active stations. The resulting signaling structure may support consistent beamforming semantics across single-user, multi-user, and coordinated beamforming modes while reducing overhead and transition latency between modes. These improvements may provide more efficient use of spectral resources, enhanced throughput, and increased flexibility for next-generation WLAN systems operating under advanced beamforming configurations.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “beamforming protocol” refers to any signaling and transmission procedure configured to perform sounding, receive channel state information, and adjust transmission parameters based on the received channel state information. A beamforming protocol may include, for example, single-user beamforming procedures, multi-user beamforming procedures, coordinated beamforming procedures, or combinations thereof. The beamforming protocol may encompass generation and transmission of sounding control frames, receipt and processing of sounding results, derivation of pre-coding weights and spatial stream allocations, and initiation of beamformed data transmissions in accordance with IEEE 802.11 WLAN signaling semantics. The beamforming protocol may be implemented using hardware, firmware, software, or any combination thereof within one or more access points, stations, or network-based control entities.

As used herein, the term “multi-user format” refers to a channel state information format that conforms to multi-user sounding signaling semantics and includes feedback fields suitable for multi-user or coordinated beamforming procedures. The multi-user format may include, without limitation, defined grouping parameters, codebook selection indicators, singular value information, per-subcarrier metrics, or other multi-user feedback elements specified by the IEEE 802.11 WLAN specification. A sounding result in a multi-user format may be generated even where only a single active station participates in a sounding exchange, provided that the signaling structure and feedback configuration apply multi-user frame structure requirements.

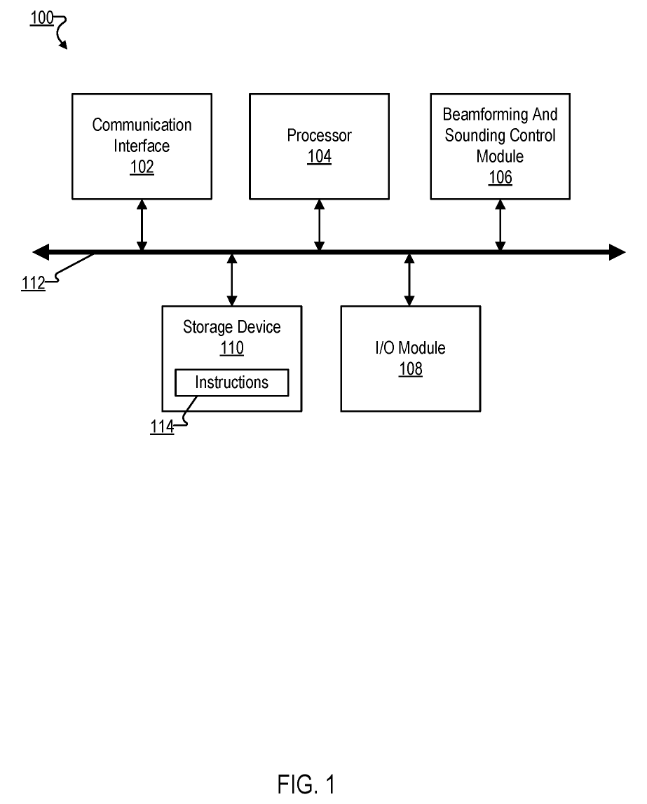

FIG. 1 illustrates an example computing device 100 that may be specifically configured to perform one or more of the beamforming and sounding operations described herein associated with re-use of multi-user sounding results in wireless beamforming systems. As shown in FIG. 1, the computing device 100 may include a communication interface 102, a processor 104, a beamforming and sounding control module 106, an input and output (I/O) module 108, and a storage device 110 configured to store instructions 114. The communication interface 102, the processor 104, the beamforming and sounding control module 106, the I/O module 108, and the storage device 110 may be communicatively connected to one another via a communication infrastructure 112. The instructions 114, when executed by the processor 104, may cause the computing device 100 to perform operations associated with generating and transmitting sounding control frames, transmitting NDPs, receiving multi-user formatted sounding results, deriving channel state information, and initiating multi-user or coordinated beamforming procedures based on re-use of the received sounding results. While the computing device 100 is illustrated in FIG. 1, the illustrated components are not intended to be limiting, and additional or alternative components may be used in other embodiments.

The communication interface 102 may be configured to communicate with one or more external systems that provide wireless signals, sounding frames, channel state information, or other data to, or receive transmission frames from, the computing device 100. For example, the communication interface 102 may enable wireless communication with one or more stations, access points, or other network nodes operating in accordance with the IEEE 802.11 WLAN specification. As another example, the communication interface 102 may enable transmission of sounding control frames, NDPs, beamformed data frames, or control information to external wireless devices, and receipt of multi-user formatted sounding results from such devices. The communication interface 102 may include, without limitation, a radio frequency (RF) transceiver, baseband processing circuitry, antenna arrays, wired network interfaces, or other communication modules configured for data exchange across local, distributed, or cloud-based networking environments. In some embodiments, the communication interface 102 may include encryption, authentication, or access-control mechanisms to support secure transmission of sounding frames, channel state information, and beamforming-related signaling.

The processor 104 generally represents one or more processing units capable of executing operations of the computing device 100 associated with beamforming, sounding control, and channel state information processing. The processor 104 may execute the instructions 114 stored in the storage device 110 to perform operations including generating and transmitting sounding control frames, transmitting NDPs, receiving multi-user formatted sounding results, decoding channel state information, deriving pre-coding weights, allocating spatial streams, and initiating multi-user or coordinated beamforming procedures. The processor 104 may include one or more general-purpose processing units, digital signal processors (DSPs), baseband processors, or other processing resources configured to perform signal processing, medium access control operations, and beamforming control logic. In some embodiments, the processor 104 may coordinate execution across multiple processing cores or hardware accelerators to support real-time processing of sounding exchanges and beamforming operations in high-throughput WLAN environments.

The beamforming and sounding control module 106 may be configured to perform control operations that support sounding exchanges, channel state information processing, and initiation of beamforming procedures. The beamforming and sounding control module 106 may include one or more sub-modules configured to generate NDPA frames, configure feedback format indicators, schedule transmission of NDPs, and process multi-user formatted sounding results received from one or more stations. In some embodiments, the beamforming and sounding control module 106 may implement control logic for identifying a station to receive a multi-user sounding control frame, designating a dummy station for compliance with multi-user signaling semantics, and coordinating transmission timing among multiple access points in a coordinated beamforming procedure. In other embodiments, the beamforming and sounding control module 106 may include logic for validating received channel state information, determining re-use eligibility based on channel coherence characteristics, and initiating multi-user or coordinated beamforming protocols using previously obtained multi-user formatted sounding results. The beamforming and sounding control module 106 may operate in coordination with the processor 104 to execute the sounding and beamforming workflows of the methods described herein.

The I/O module 108 may include one or more input and output devices configured to receive configuration input and present operational data generated by the computing device 100. The I/O module 108 may include any suitable combination of hardware, firmware, and software that supports configuration, monitoring, and visualization of sounding and beamforming operations. For input, the I/O module 108 may include interfaces for configuring sounding parameters, selecting feedback format indicators, initiating multi-user or coordinated beamforming protocols, or defining re-use thresholds for previously obtained channel state information. For output, the I/O module 108 may include displays, dashboards, logs, or graphical user interfaces configured to present sounding status information, received multi-user formatted channel state information summaries, transmission scheduling data, beamforming configuration parameters, or performance indicators associated with multi-user and coordinated beamforming workflows.

The storage device 110 may include one or more types of non-volatile storage media and may be configured to store the instructions 114 along with data used or generated by the computing device 100. The storage device 110 may maintain sounding configuration parameters, transmitted and received frame information associated with the sounding control frame and the NDP, channel state information received from one or more stations, scheduling data, beamforming parameter sets, and re-use validity intervals associated with previously obtained sounding results. In some embodiments, the storage device 110 may include structured data repositories or databases configured to organize historical sounding exchanges, multi-user formatted feedback records, capability information associated with stations, and coordination parameters associated with multiple access points to support traceability, analysis, auditing, and continued optimization of beamforming operations. The storage device 110 may further integrate with distributed or cloud-based storage resources to enable scalable data management across local, distributed, or networked computing environments.

The communication infrastructure 112 represents an internal interconnect architecture that links the communication interface 102, the processor 104, the beamforming and sounding control module 106, the I/O module 108, and the storage device 110 within the computing device 100. The communication infrastructure 112 may support exchange of sounding configuration parameters, transmitted and received frame information, channel state information, scheduling data, beamforming weights, coordination parameters, and control signals between components of the computing device 100. In some embodiments, the communication infrastructure 112 may be implemented using one or more buses, high-speed interconnect fabrics, or network-on-chip architectures configured to provide sufficient throughput and latency characteristics to support coordinated execution of sounding, channel estimation processing, feedback decoding, beamforming parameter computation, and re-use operations described herein.

The instructions 114 stored in the storage device 110 may define operations that, when executed by the processor 104, enable the computing device 100 to perform one or more processes associated with sounding, channel state information processing, and beamforming control. The instructions 114 may include routines for generating and transmitting a sounding control frame, transmitting an associated NDP, receiving a sounding result in a multi-user format, decoding channel state information, determining validity of the channel state information, deriving pre-coding weights and spatial stream allocations, and initiating multi-user or coordinated beamforming procedures. When executed, the instructions 114 may coordinate operation of the communication interface 102, the processor 104, the beamforming and sounding control module 106, the I/O module 108, and the storage device 110 to enable the computing device 100 to function as an integrated platform for managing multi-user sounding exchanges and re-use of multi-user formatted channel state information across beamforming modes.

By combining these components, the computing device 100 is configured to execute the processes described herein for performing sounding operations and re-using multi-user formatted channel state information in single-user, multi-user, or coordinated beamforming procedures. In particular, the computing device 100 supports operations including identifying a station for participation in a multi-user sounding exchange, generating and transmitting a multi-user sounding control frame, transmitting an associated NDP, receiving a sounding result in a multi-user format, decoding and storing channel state information, deriving pre-coding weights and spatial stream allocations, and initiating multi-user or coordinated beamforming transmissions based on the received channel state information. The integrated architecture of the computing device 100 may enable coordinated control of sounding exchanges, channel estimation processing, and beamforming configuration under signaling and timing constraints defined by the IEEE 802.11 WLAN specification.

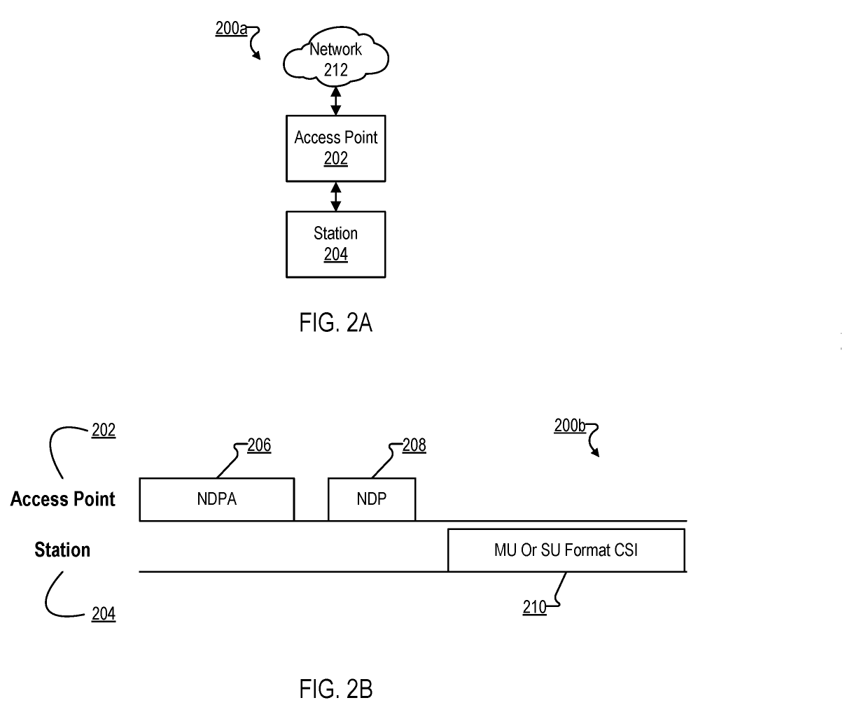

FIG. 1 therefore illustrates an example computing device 100 configured to perform one or more sounding and beamforming control operations described herein. The described configuration may enable the computing device 100 to generate and transmit sounding control frames and NDPs, receive multi-user formatted channel state information from one or more stations, and control re-use of sounding results across single-user, multi-user, and coordinated beamforming procedures in accordance with IEEE 802.11 signaling semantics. FIG. 2A sets forth an example wireless communication environment in which one or more instances of the computing device 100 may operate to perform sounding exchanges and manage multi-user formatted channel state information in accordance with embodiments of the present disclosure.

In one or more embodiments, FIG. 2A illustrates an example wireless communication environment 200a in which the computing device 100 of FIG. 1 may be deployed to perform sounding and channel state information management operations in accordance with embodiments of the present disclosure. The wireless communication environment 200a may include at least one access point 202, one or more stations 204, and a network 212 communicatively coupling the access point 202 and the one or more stations 204 within a WLAN implemented in accordance with the IEEE 802.11 WLAN specification. In some embodiments, the computing device 100 may be implemented within the access point 202, within the station 204, or within a network-based control entity coupled to the network 212 and configured to coordinate operations among multiple access points 202 and stations 204. The computing device 100, when deployed within or communicatively coupled to the network 212, may control transmission of sounding control frames including a multi-user NDPA frame 206 and one or more NDPs 208, and may process multi-user formatted channel state information 210 generated by the station 204 for use in subsequent multi-user or coordinated beamforming operations under signaling and timing constraints governed by the IEEE 802.11 WLAN specification.

For further explanation, FIG. 2B depicts an example system 200b, which may represent a more detailed implementation of the wireless communication environment 200a of FIG. 2A that may be configured for performing sounding operations and receiving the channel state information 210 in a wireless beamforming environment in accordance with embodiments of the present disclosure. The example system 200b may include the access point 202 and the station 204 operating within a WLAN implemented in accordance with the IEEE 802.11 WLAN specification, where frame sequencing rules, inter-frame spacing requirements, and bandwidth constraints govern signaling exchanges. In one or more examples, the access point 202 may be configured to initiate sounding procedures, generate sounding control frames, and process received channel state information for pre-coding and spatial stream allocation. As another example, the station 204 may be configured to estimate wireless channel characteristics based on received reference signals and to transmit the channel state information 210 to the access point 202. The access point 202 may transmit the NDPA frame 206 to the station 204 to initiate a sounding exchange and to convey sounding configuration parameters, followed by transmission of the NDP 208 used by the station 204 to perform channel estimation. The station 204 may generate the channel state information 210 in either single-user format or multi-user format based on sounding configuration and capability parameters, and the station 204 may transmit the channel state information 210 to the access point 202 for use in subsequent beamforming operations.

In one or more examples, the NDPA frame 206 may include sounding configuration fields that identify the station 204, specify feedback format parameters, and indicate whether the channel state information 210 is to be provided in single-user format or multi-user format. The NDP 208 may include one or more training symbols distributed across spatial streams and subcarriers to enable accurate channel estimation at the station 204. The station 204 may process the NDP 208 using channel estimation logic and feedback encoding circuitry to generate the channel state information 210 in accordance with capability parameters negotiated between the access point 202 and the station 204. The access point 202 may utilize the received channel state information 210 to initiate single-user beamforming or multi-user beamforming, or coordinated beamforming procedures as described in subsequent figures, thereby enabling flexible re-use of sounding results under signaling and bandwidth constraints present in the WLAN environment.

In one or more examples, the channel state information 210 may include a compressed representation of a channel matrix derived from the estimated wireless channel between the access point 202 and the station 204. The channel state information 210 may include pre-coding matrix information, singular value information, per-subcarrier quality metrics, or other feedback parameters suitable for single-user or multi-user beamforming operations. The access point 202 may receive the channel state information 210 within a defined feedback interval governed by medium access control timing constraints and rate adaptation rules specified by the IEEE 802.11 WLAN specification. The access point 202 may store and process the channel state information 210 to determine spatial stream allocation, modulation and coding schemes, and beamforming weights for subsequent transmissions directed to the station 204. The structural relationship between the access point 202 and the station 204, both of which are configured to participate in the transmission and/or receipt of the NDPA frame 206, the NDP 208, and the channel state information 210, may support execution of the sounding and beamforming methods described with reference to the subsequent figures.

In one or more examples, the access point 202 may be configured to utilize the channel state information 210 obtained from the station 204 to initiate subsequent beamforming transmissions directed to the station 204 or to coordinate transmissions with one or more additional access points in a coordinated beamforming procedure. The access point 202 may derive pre-coding weights, spatial stream allocations, and modulation and coding parameters based on feedback parameters included in the channel state information 210. The access point 202 may further determine whether the channel state information 210 is suitable for single-user beamforming operations or multi-user beamforming operations based on the format and capability parameters associated with the channel state information 210 or suitable coordinated beamforming operations in which multiple access points may cooperate to transmit to one or more stations. The described configuration enables the access point 202 and the station 204 to cooperate in executing sounding exchanges and subsequent beamforming procedures under timing, signaling, and bandwidth constraints present in the WLAN environment.

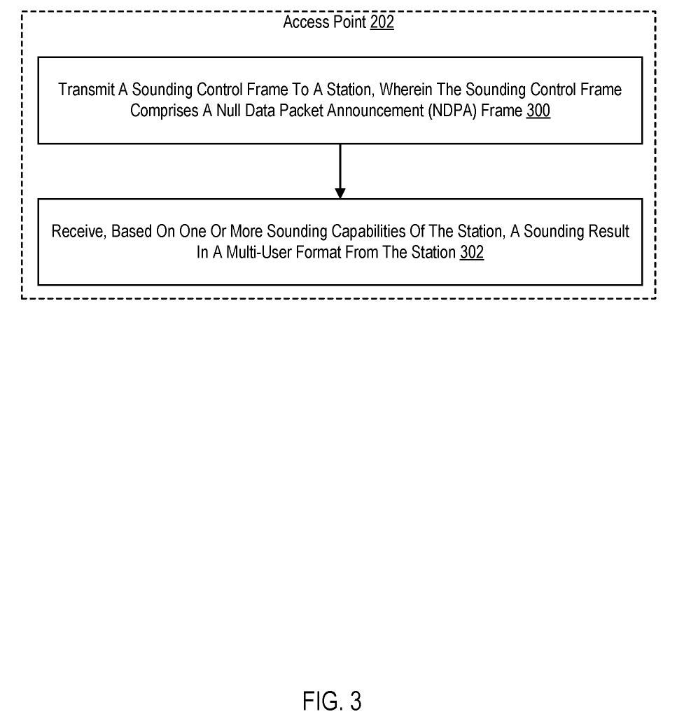

FIG. 2B thus illustrates an example arrangement of the access point 202 and the station 204 participating in a sounding exchange through transmission of the NDPA frame 206, the NDP 208, and the channel state information 210. While FIG. 2B emphasizes the overall signaling relationship and functional interaction between the access point 202 and the station 204 within a WLAN environment, FIG. 3 provides a flow diagram that illustrates method operations associated with transmission of the NDPA frame 206 and receipt of multi-user formatted channel state information from the station. FIG. 3 further depicts operational steps that may be performed by the access point in cooperation with the station to enable subsequent beamforming procedures.

For further explanation, FIG. 3 sets forth a flowchart illustrating an example method of performing a beamforming protocol in accordance with embodiments of the present disclosure. The example method of FIG. 3 can be carried out in a system similar to that of FIGS. 1, 2A, and/or 2B. The method of FIG. 3 can be performed by an access point (e.g., the access point 202) configured to transmit a sounding control frame and to receive channel state information (e.g., the channel state information 210) from a station (e.g., the station 204). In one or more embodiments, the sounding control frame may comprise a NDPA frame (e.g., the NDPA frame 206), although other sounding control frame formats may be used.

The method of FIG. 3 includes transmitting 300, from an access point, a sounding control frame to a station. Transmitting 300 the sounding control frame may be carried out by generating the sounding control frame and providing the sounding control frame to transmission circuitry for wireless transmission to the station 204. In one or more examples, transmitting 300 the sounding control frame may include populating sounding configuration fields that can identify the station 204 and specify feedback format parameters associated with a subsequent sounding result. Transmitting 300 the sounding control frame may further include scheduling transmission of the sounding control frame in accordance with medium access control timing constraints defined by the IEEE 802.11 WLAN specification. In some embodiments, transmitting 300 the sounding control frame may precede transmission of a NDP (e.g., the NDP 208) that can provide reference symbols used by the station 204 to estimate channel characteristics.

In some embodiments, transmitting 300 the sounding control frame may include configuring the sounding control frame to request that the station 204 return a sounding result in a multi-user format. For example, transmitting 300 the sounding control frame may include setting one or more feedback format indicators within the sounding control frame to specify multi-user formatted channel state information 210. In other embodiments, transmitting 300 the sounding control frame may include selecting sounding parameters based on capability information associated with the station 204 to ensure compatibility with multi-user feedback generation. Transmitting 300 the sounding control frame may further include scheduling the sounding control frame for transmission within a defined transmission opportunity in accordance with medium access control rules specified by the IEEE 802.11 WLAN specification.

The method of FIG. 3 also includes receiving 302, at the access point and based on one or more sounding capabilities of the station, a sounding result in a multi-user format from the station. Receiving 302 the sounding result may be carried out by detecting a feedback transmission from the station 204 and decoding the channel state information 210 formatted in accordance with multi-user feedback parameters. In one or more examples, the received sounding result may include the channel state information 210 corresponding to the access point 202, where the channel state information 210 represents channel characteristics between the station 204 and the access point 202. In other examples, the sounding capabilities of the station 204 may include support for multi-user feedback encoding, support for inclusion of singular value information in the channel state information 210, support for per-subcarrier quality metrics, support for defined feedback codebooks, or support for specified grouping parameters. In some embodiments, receiving 302 the sounding result may include determining that the station 204 can advertise multi-user feedback capability during an association procedure or within capability information conveyed in the sounding control frame. Receiving 302 the sounding result may further include validating that the channel state information 210 can conform to multi-user formatting rules defined by the IEEE 802.11 WLAN specification prior to storing and processing the channel state information 210 for subsequent beamforming transmissions.

In some embodiments, receiving 302 the sounding result may include determining whether the sounding result satisfies predefined validation criteria prior to use in a subsequent beamforming procedure. For example, receiving 302 the sounding result may include evaluating whether the channel state information 210 includes required multi-user format fields, verifying that feedback parameters correspond to sounding configuration fields specified in the sounding control frame, and confirming that feedback timing complies with inter-frame spacing constraints defined by the IEEE 802.11 WLAN specification. In other embodiments, receiving 302 the sounding result may include rejecting the channel state information 210 that does not conform to multi-user formatting rules and initiating a subsequent sounding exchange. In further embodiments, receiving 302 the sounding result may include storing the channel state information 210 with an associated validity interval corresponding to channel coherence characteristics of the station 204 to support re-use of the channel state information 210 in later beamforming operations.

The method steps of FIG. 3 collectively describe a process for obtaining multi-user formatted channel state information from a station during a sounding exchange. Transmitting 300 the sounding control frame to the station and receiving 302 the sounding result in a multi-user format cooperate to enable the access point to obtain channel state information that is suitable for multi-user beamforming operations or coordinated beamforming operations, even where only a single station participates in the sounding procedure. Through these operations, the access point may initiate sounding using defined signaling parameters and subsequently process the channel state information that includes multi-user format elements such as singular value information and per-subcarrier quality metrics. The coordinated execution of transmitting 300 the sounding control frame and receiving 302 the multi-user formatted sounding result may reduce a number of frame exchanges, support re-use of channel state information across beamforming modes, and improve signaling efficiency under bandwidth and timing constraints defined by the IEEE 802.11 WLAN specification.

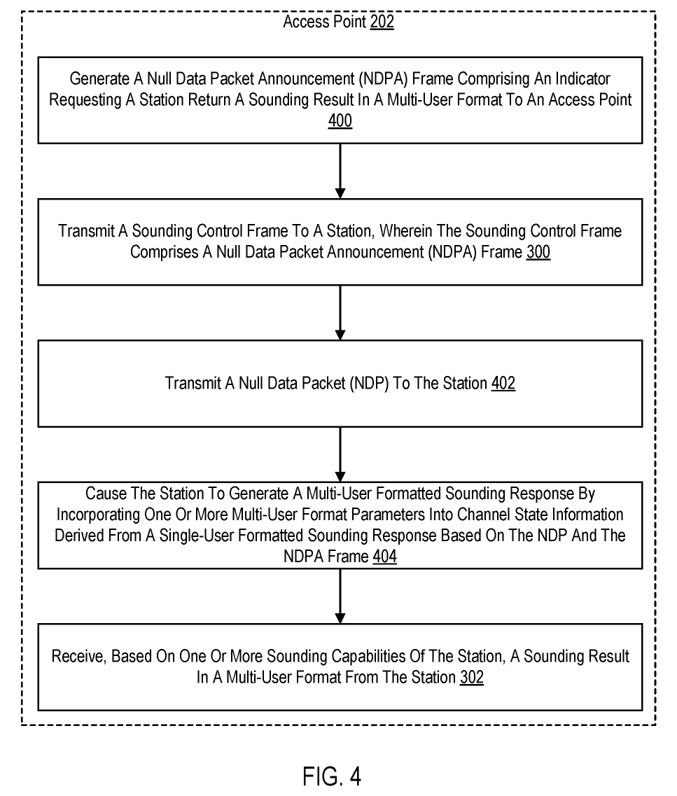

FIG. 3 therefore illustrates an example method executed by the access point for performing a beamforming protocol that may include obtaining multi-user formatted channel state information from a station for use in multi-user beamforming or coordinated beamforming procedures. The sequence of operations shown in FIG. 3 demonstrates how the access point may transition from transmitting 300 the sounding control frame to receiving 302 the channel state information formatted in accordance with multi-user feedback parameters. FIG. 4 sets forth a flowchart illustrating an example method that expands upon the operations described with reference to FIG. 3 by detailing additional operations including generating the NDPA frame comprising an indicator requesting multi-user formatted feedback, transmitting a sounding control frame comprising the NDPA frame, transmitting an NDP associated with the NDPA frame, and causing generation of a multi-user formatted sounding response as further described herein.

For further explanation, FIG. 4 sets forth a flowchart illustrating an example method of generating a NDPA frame (e.g., the NDPA frame 206), transmitting an associated NDP (e.g., the NDP 208), and causing generation of a multi-user formatted sounding response in accordance with embodiments of the present disclosure. The example method of FIG. 4 can be carried out in a system similar to that of FIGS. 1, 2A, and/or 2B. The method of FIG. 4 can be performed by an access point (e.g., the access point 202) configured to generate the NDPA frame 206, transmit the NDP 208, and receive channel state information (e.g., the channel state information 210) from a station (e.g., the station 204) wherein the access point 202 causes the station 204 to generate a multi-user formatted sounding response based on the transmitted NDPA frame 206 and the NDP 208. In one or more embodiments, the sounding control frame may comprise a NDPA frame (e.g., the NDPA frame 206), although other sounding control frame formats may be used.

The method of FIG. 4 includes generating 400, by the access point, a NDPA frame comprising an indicator requesting that the station return a sounding result in a multi-user format to the access point. Generating 400 the NDPA frame 206 may be carried out by constructing the NDPA frame 206 to include one or more feedback format indicators that specify the multi-user formatted channel state information 210. In one or more examples, generating 400 the NDPA frame 206 may include setting a feedback type field, grouping parameter, codebook selection field, or other format-related control field to designate multi-user feedback. Generating 400 the NDPA frame 206 may further include selecting sounding parameters based on capability information associated with the station 204 that may be obtained during an association procedure, conveyed within capability information elements exchanged prior to the sounding exchange, stored within a capability profile maintained by the access point 202, or determined according to predefined configuration rules supported by the IEEE 802.11 WLAN specification.

In some embodiments, generating 400 the NDPA frame 206 may include dynamically selecting the indicator requesting multi-user formatted feedback based on operational conditions associated with the access point 202 or the station 204. For example, generating 400 the NDPA frame 206 may include determining that the multi-user formatted channel state information 210 is required for a subsequent multi-user beamforming procedure operation and setting the indicator accordingly. In other embodiments, generating 400 the NDPA frame 206 may include evaluating channel quality history, traffic demand, spatial stream configuration, or policy rules maintained by the access point 202 to determine whether multi-user feedback should be requested. Generating 400 the NDPA frame 206 may further include encoding the selected indicator within a defined feedback format field in accordance with signaling rules specified by the IEEE 802.11 WLAN specification.

In the method of FIG. 4, generating 400 the NDPA frame 206 may be followed by transmitting 300 the sounding control frame, as described with reference to FIG. 3, which may precede transmitting 402 the NDP 208, as is further described herein. In the method of FIG. 4, transmitting 300 the sounding control frame may be performed as described with reference to FIG. 3 such that sounding configuration parameters and feedback format indicators are established prior to transmission of the NDP 208. Following the transmission 300 of the sounding control frame comprising the NDPA frame 206, the method of FIG. 4 may include transmitting 402 the NDP 208 to the station 204. Performance of transmitting 300 the sounding control frame prior to transmitting 402 the NDP 208 may ensure that channel estimation at the station 204 is performed in accordance with sounding configuration parameters specified in the NDPA frame 206.

More specifically, transmitting 402 the NDP 208 to the station 204 may be carried out by providing the NDP 208 to transmission circuitry of the access point 202 following transmission 300 of the sounding control frame. The NDP 208 may include training symbols distributed across spatial streams and subcarriers that can enable the station 204 to estimate channel coefficients corresponding to the wireless channel between the access point 202 and the station 204. Transmitting 402 the NDP 208 may therefore initiate channel estimation at the station 204 in accordance with sounding configuration parameters specified in the NDPA frame 206. Transmission 402 of the NDP 208 may establish the basis for subsequent generation of the multi-user formatted sounding response derived from channel characteristics measured during reception of the NDP 208.

In some embodiments, transmitting 402 the NDP 208 may include selecting a bandwidth, number of spatial streams or modulation parameters consistent with multi-user sounding requirements. For example, transmitting 402 the NDP 208 may include configuring training symbols across a predefined set of subcarriers that correspond to multi-user feedback grouping parameters supported by the station 204. In other embodiments, transmitting 402 the NDP 208 may include synchronizing transmission timing with inter-frame spacing requirements defined by the IEEE 802.11 WLAN specification to ensure that the station 204 performs channel estimation within a defined sounding interval. Transmission 402 of the NDP 208 in accordance with selected bandwidth, spatial stream configuration, and timing constraints may enable the station 204 to derive channel measurements suitable for generation of a multi-user formatted sounding response.

The method of FIG. 4 further includes causing 404, by the access point, the station to generate the multi-user formatted sounding response by incorporating one or more multi-user format parameters into channel state information derived from a single-user formatted sounding response based on the NDP and the NDPA frame. Causing 404 the station 204 to generate the multi-user formatted sounding response may be carried out by transmitting the NDPA frame 206 and the NDP 208 with feedback format indicators that designate multi-user formatting. In response to receipt of the NDPA frame 206 and the NDP 208, the station 204 may perform channel estimation using the NDP 208 and may generate the channel state information 210 formatted in accordance with multi-user feedback parameters indicated in the NDPA frame 206. The station 204 may incorporate the one or more multi-user format parameters into the channel state information prior to transmitting the sounding result to the access point 202.

In some embodiments, the station 204 may generate the multi-user formatted sounding response by appending singular value information, per-subcarrier signal-to-noise ratio metrics, grouping parameters, or defined feedback compression fields to a base channel matrix representation derived from the NDP 208. The station 204 may determine inclusion of such multi-user format elements based on feedback configuration indicators contained in the NDPA frame 206 and capability information associated with the station 204. Generation of the multi-user formatted sounding response may therefore produce channel state information 210 suitable for multi-user beamforming operations while originating from a sounding exchange involving the station 204.

In the method of FIG. 4, the sounding result may be received 302 after causing 404 the station 204 to generate the multi-user formatted sounding response. Following transmission of the sounding control frame comprising the NDPA frame 206, the NDP 208, and after causing 404 the station 204 to generate the multi-user formatted sounding response, the access point 202 may detect a feedback transmission from the station 204 and decode the channel state information 210 formatted in accordance with the multi-user feedback parameters. Receiving 302 the sounding result at the conclusion of causing 404 the station 204 to generate the multi-user formatted sounding response may enable the access point 202 to obtain and process the multi-user formatted channel state information 210 generated based on the single-user formatted sounding response.

The method steps of FIG. 4 collectively describe a process for configuring a sounding control frame, transmitting an associated NDP, and generating a multi-user formatted sounding response from a station during a sounding exchange. Generating 400 the NDPA frame with an indicator requesting multi-user formatted feedback, transmitting 300 the sounding control frame, transmitting 402 the NDP, causing 404 the station to generate the multi-user formatted sounding response, and receiving 302 the sounding result, cooperate to ensure that the sounding exchange may produce channel state information formatted in accordance with multi-user feedback parameters. Through these operations, the access point may control the feedback format at the initiation of the sounding exchange and subsequently obtain channel state information that includes multi-user format elements such as singular value information and per-subcarrier quality metrics. The coordinated execution of generating 400 the NDPA frame, transmitting 300 the sounding control frame comprising the NDPA frame, transmitting 402 the NDP, causing 404 the station to generate the multi-user formatted sounding response, and receiving 302 the sounding result may enable deterministic selection of feedback format, reduce ambiguity in feedback interpretation, and improve interoperability under signaling constraints defined by the IEEE 802.11 WLAN specification, including signaling requirements applicable to coordinated beamforming procedures.

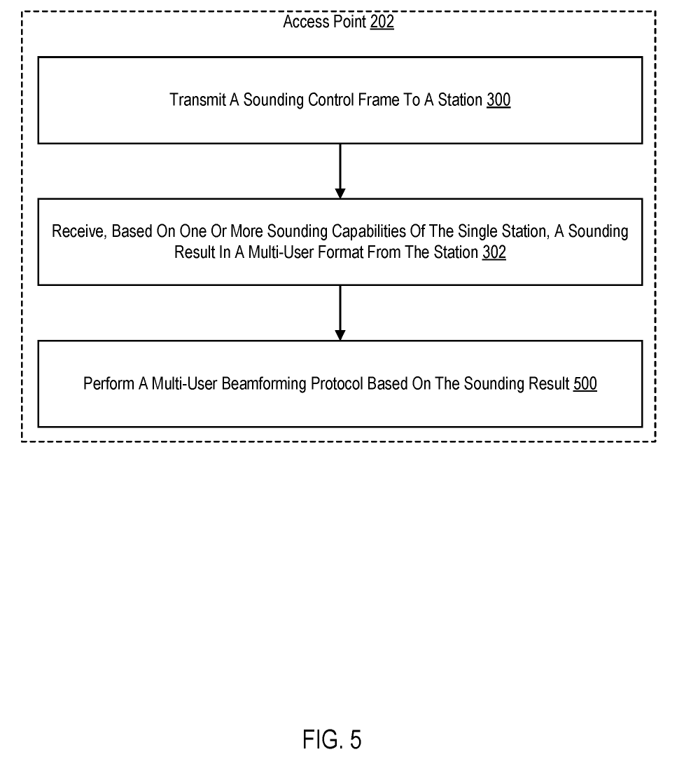

FIG. 4 therefore illustrates an example method executed by the access point for performing a beamforming protocol that may include configuring a sounding control frame, transmitting an associated NDP, and obtaining a multi-user formatted sounding result from a station. The sequence of operations shown in FIG. 4 demonstrates how the access point may transition from generating 400 the NDPA frame to transmitting 300 the sounding control frame comprising the NDPA frame, transmitting 402 the NDP, causing 404 the station to generate the multi-user formatted sounding response, and subsequently receiving 302 channel state information formatted in accordance with the designated multi-user feedback parameters. FIG. 5 sets forth a flowchart illustrating an example method that expands upon the operations described with reference to FIG. 3 by detailing additional operations directed toward the utilization of the multi-user formatted sounding result in a subsequent beamforming protocol, as further described herein.

For further explanation, FIG. 5 sets forth a flowchart illustrating an example method of performing a multi-user beamforming protocol based on a multi-user formatted sounding result in accordance with embodiments of the present disclosure. The example method of FIG. 5 can be carried out in a system similar to that of FIGS. 1, 2A, and/or 2B. The method of FIG. 5 can be performed by an access point (e.g., the access point 202) configured to transmit a sounding control frame, receive channel state information (e.g., the channel state information 210) from a station (e.g., the station 204) and perform a multi-user beamforming protocol based on the received channel state information 210. In one or more embodiments, the sounding control frame may comprise a NDPA frame (e.g., the NDPA frame 206), although other sounding control frame formats may be used.

The method of FIG. 5 discloses the transmission 300 of the sounding control frame to the station 204 and receiving 302 the sounding result in a multi-user format from the station 204 as described with reference to FIG. 3, which may precede performing 500 the multi-user beamforming protocol, as is further described herein. In the method of FIG. 5, transmitting 300 the sounding control frame and receiving 302 the sounding result may be performed as described with reference to FIG. 3 such that the channel state information 210 formatted in accordance with multi-user feedback parameters may be obtained prior to performing 500 the multi-user beamforming protocol. Following the transmission 300 of the sounding control frame and receiving 302 the sounding result, the method of FIG. 5 may include performing 500 the multi-user beamforming protocol based on the channel state information 210. Transmitting 300 the sounding control frame and receiving 302 the sounding result prior to performing 500 the multi-user beamforming protocol may ensure that the access point 202 utilizes the channel state information 210 reflective of current channel characteristics associated with the station 204.

More specifically, performing 500 the multi-user beamforming protocol may be carried out by utilizing the channel state information 210 to derive pre-coding weights and spatial stream allocations for transmission to the station 204. The channel state information 210 can include singular value information, pre-coding matrix information, or per-subcarrier quality metrics that may enable the access point 202 to construct beamforming transmission frames suitable for multi-user operation. Performing 500 the multi-user beamforming protocol may therefore include configuring one or more spatial streams as well as modulation and coding parameters based on the multi-user formatted channel state information 210. Performance of the multi-user beamforming protocol based on the channel state information 210 may establish the basis for subsequent data transmissions that can leverage previously obtained multi-user formatted sounding results without requiring an additional sounding exchange.

In some embodiments, performing 500 the multi-user beamforming protocol may include determining whether the channel state information 210 remains valid for re-use based on a defined channel coherence interval associated with the station 204. For example, performing 500 the multi-user beamforming protocol may include evaluating elapsed time since receiving 302 the sounding result, mobility characteristics associated with the station 204, or predefined re-use thresholds maintained by the access point 202. In other embodiments, performing 500 the multi-user beamforming protocol may include combining the channel state information 210 with scheduling information or traffic demand parameters to allocate spatial streams across multiple users in a multi-user transmission opportunity. Performing 500 the multi-user beamforming protocol under these conditions may enable re-use of the multi-user formatted channel state information 210 while maintaining compliance with signaling and timing constraints defined by the IEEE 802.11 WLAN specification.

The method steps of FIG. 5 collectively describe a process for re-using a multi-user formatted sounding result to perform a multi-user beamforming protocol. Transmitting 300 the sounding control frame to the station and receiving 302 the sounding result in a multi-user format, followed by performing 500 the multi-user beamforming protocol, cooperate to enable the access point to utilize previously obtained channel state information without performing an additional sounding exchange. Through these operations, the access point may apply precoding weights, spatial stream allocations, as well as modulation and coding parameters derived from the multi-user formatted channel state information to subsequent data transmissions. The coordinated execution of transmitting 300 the sounding control frame, receiving 302 the sounding result, and performing 500 the multi-user beamforming protocol may reduce signaling overhead, support re-use of channel state information across beamforming modes, and improve spectral efficiency under signaling constraints defined by the IEEE 802.11 WLAN specification.

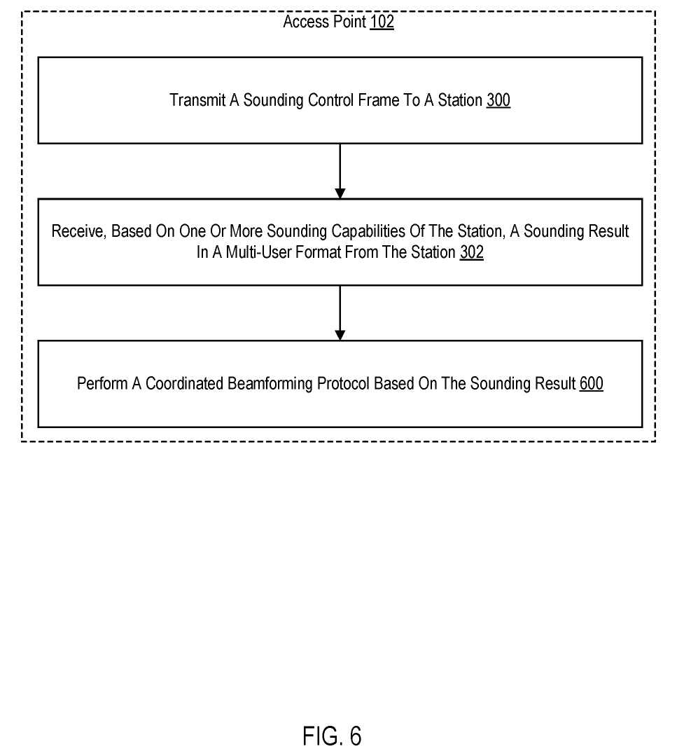

FIG. 5 therefore illustrates an example method executed by the access point for performing a beamforming protocol that includes utilizing multi-user formatted channel state information in a subsequent multi-user beamforming procedure. The sequence of operations shown in FIG. 5 demonstrates how the access point may transition from receiving 302 the sounding result in a multi-user format to performing 500 the multi-user beamforming protocol based on the received channel state information. FIG. 6 sets forth a flowchart illustrating an example method that expands upon the operations described with reference to FIG. 3 by detailing additional operations associated with re-use of the multi-user formatted sounding result in a coordinated beamforming protocol, as further described herein.

For further explanation, FIG. 6 sets forth a flowchart illustrating an example method of performing a coordinated beamforming protocol based on a multi-user formatted sounding result in accordance with embodiments of the present disclosure. The example method of FIG. 6 can be carried out in a system similar to that of FIGS. 1, 2A, and/or 2B. The method of FIG. 6 can be performed by an access point (e.g., the access point 202) configured to transmit a sounding control frame, receive channel state information (e.g., the channel state information 210) from a station (e.g., the station 204) and perform a coordinated beamforming protocol based on the received multi-user formatted channel state information 210. In one or more embodiments, the sounding control frame may comprise a NDPA frame (e.g., the NDPA frame 206), although other sounding control frame formats may be used.

The method of FIG. 6 discloses the transmission 300 of the sounding control frame to the station and receiving 302 the sounding result in a multi-user format from the station 204 as described with reference to FIG. 3, which may precede performing 600 the coordinated beamforming protocol, as is further described herein. In the method of FIG. 6, transmitting 300 the sounding control frame and receiving 302 the sounding result may be performed as described with reference to FIG. 3 such that the channel state information 210 formatted in accordance with multi-user feedback parameters is obtained prior to performing 600 the coordinated beamforming protocol. Following the transmission 300 of the sounding control frame and receiving 302 the sounding result, the method of FIG. 6 may include performing 600 the coordinated beamforming protocol based on the channel state information 210. Transmitting 300 the sounding control frame and receiving 302 the sounding result prior to performing 600 the coordinated beamforming protocol may ensure that the access point 202 utilizes the channel state information 210 reflective of current channel characteristics associated with the station 204 in coordinating transmissions with one or more additional access points.

More specifically, performing 600 the coordinated beamforming protocol may be carried out by utilizing the channel state information 210 to derive pre-coding weights and spatial stream allocations for coordinated transmission to the station 204 in cooperation with one or more additional access points. The channel state information 210 may include singular value information, pre-coding matrix information, or per-subcarrier quality metrics that enable the access point 202 to construct coordinated beamforming transmission frames that can account for interference mitigation and spatial alignment across multiple transmitting access points. Performing 600 the coordinated beamforming protocol may therefore include configuring one or more spatial streams as well as modulation and coding parameters based on the multi-user formatted channel state information 210 while coordinating transmission timing and beamforming vectors with the one or more additional access points. Performance of the coordinated beamforming protocol based on the channel state information 210 may establish the basis for subsequent coordinated data transmissions that can leverage previously obtained multi-user formatted sounding results without requiring an additional sounding exchange.

In some embodiments, performing 600 the coordinated beamforming protocol may include determining whether the channel state information 210 remains valid for re-use based on a defined channel coherence interval associated with the station 204 and coordination timing constraints associated with one or more additional access points. For example, performing 600 the coordinated beamforming protocol may include evaluating elapsed time since receiving 302 the sounding result, mobility characteristics associated with the station 204, synchronization status among participating access points, or predefined re-use thresholds maintained by the access point 202. In other embodiments, performing 600 the coordinated beamforming protocol may include combining the channel state information 210 with coordination parameters such as transmission scheduling information, interference alignment data, or spatial stream allocation policies shared among cooperating access points. Performing 600 the coordinated beamforming protocol under these conditions may enable re-use of the multi-user formatted channel state information 210 while maintaining compliance with signaling, synchronization, and timing constraints defined by the IEEE 802.11 WLAN specification.

The method steps of FIG. 6 collectively describe a process for re-using a multi-user formatted sounding result to perform a coordinated beamforming protocol. Transmitting 300 the sounding control frame to the station and receiving 302 the sounding result in a multi-user format, followed by performing 600 the coordinated beamforming protocol, cooperate to enable the access point to utilize previously obtained channel state information without performing an additional sounding exchange. Through these operations, the access point may apply pre-coding weights, spatial stream allocations, as well as modulation and coding parameters derived from the multi-user formatted channel state information while coordinating transmissions with one or more additional access points. The coordinated execution of transmitting 300 the sounding control frame, receiving 302 the sounding result, and performing 600 the coordinated beamforming protocol may reduce signaling overhead, support re-use of channel state information across beamforming modes, and improve spectral efficiency under signaling and synchronization constraints defined by the IEEE 802.11 WLAN specification.

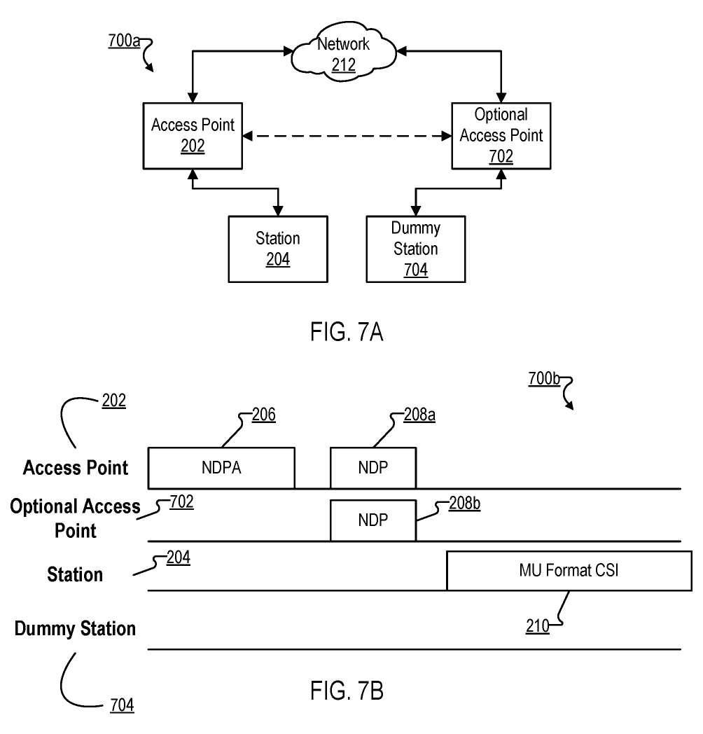

FIG. 6 therefore illustrates an example method executed by the access point for performing a beamforming protocol that includes re-using multi-user formatted channel state information in a subsequent coordinated beamforming procedure. The sequence of operations shown in FIG. 6 demonstrates how the access point may transition from receiving 302 the sounding result in a multi-user format to performing 600 the coordinated beamforming protocol based on the received channel state information. FIG. 7A sets forth a system diagram illustrating another example beamforming system distinct from the system of FIG. 2A, the example beamforming system depicting a configuration including multiple access points and at least one station participating in a multi-user or coordinated beamforming procedure, as further described herein.

In one or more embodiments, FIG. 7A illustrates an example wireless communication environment 700a in which one or more instances of the computing device 100 of FIG. 1 may be deployed to perform multi-user sounding operations involving identification of a station and a dummy station in accordance with embodiments of the present disclosure. The wireless communication environment 700a may include a first access point 202, an optional second access point 702, a station 204 designated as a single active station for a sounding exchange, a dummy station 704 identified for multi-user signaling purposes, and a network 212 communicatively coupling the access points 202 and 702 as well as the station 204 within a WLAN implemented in accordance with the IEEE 802.11 WLAN specification. In some embodiments, the computing device 100 may be implemented within the first access point 202, within the optional second access point 702, within the station 204, or within a network-based control entity coupled to the network 212 and configured to coordinate operations among the participating access points and the station 204. The computing device 100, when deployed within or communicatively coupled to the network 212, may control transmission of a multi-user NDPA frame 206 identifying the station 204 and the dummy station 704, coordinate transmission of one or more associated NDPs 208a and 208b by the first access point 202 and/or the optional second access point 702, and process multi-user formatted channel state information 210 generated by the station 204 while the dummy station 704 remains inactive for channel estimation and feedback generation under signaling and timing constraints governed by the IEEE 802.11 WLAN specification.

For further explanation, FIG. 7B depicts another example system 700b, which may represent a more detailed implementation of the wireless communication environment 700a of FIG. 7A that may be configured for performing sounding operations and receiving the channel state information 210 in a coordinated beamforming environment in accordance with embodiments of the present disclosure. The example system 700b may include a first access point 202 and an optional second access point 702 operating within a WLAN implemented in accordance with the IEEE 802.11 WLAN specification, where coordination signaling, inter-frame spacing requirements, and bandwidth constraints govern cooperative transmissions. In one or more examples, the first access point 202 and the optional second access point 702 may each be implemented as access points configured to participate in coordinated beamforming procedures. The example system 700b may further include a station 204 configured to estimate wireless channel characteristics and transmit the channel state information 210 to one or more access points, as well as a dummy station 704 that may be identified in the multi-user NDPA frame 206 for signaling purposes without participating in channel estimation. The first access point 202 and the optional second access point 702 may transmit sounding control frames, including the NDPA frame 206 and one or more NDPs 208a and 208b, to the station 204 to initiate a coordinated sounding exchange. The station 204 may generate channel state information 210 in a multi-user format based on sounding configuration parameters and transmit the channel state information 210 to the first access point 202, the optional second access point 702, or both for use in coordinated beamforming operations.

In one or more examples, the multi-user NDPA frame 206 may include sounding configuration fields that identify the station 204 and the dummy station 704, specify feedback format parameters, and indicate that the sounding result is to be provided in a multi-user format suitable for coordinated beamforming operations. The dummy station 704 may be identified within the multi-user NDPA frame 206 to satisfy multi-user sounding format requirements without participating in channel estimation or feedback generation. The NDPs 208a and 208b transmitted by the first access point 202 and the optional second access point 702 may include training symbols distributed across spatial streams and subcarriers to enable coordinated channel estimation at the station 204. The station 204 may process the NDPs 208a and 208b using channel estimation logic and feedback encoding circuitry to generate the channel state information 210 reflective of channel characteristics between the station 204 and each of the first access point 202 and the optional second access point 702. The first access point 202 and the optional second access point 702 may utilize the received channel state information 210 to derive coordinated pre-coding weights and transmission parameters for subsequent coordinated beamforming procedures.

In one or more examples, the channel state information 210 generated by the station 204 may include a compressed representation of channel matrices corresponding to wireless channels between the station 204 and each of the first access point 202 and the optional second access point 702. The channel state information 210 may include pre-coding matrix information, singular value information, per-subcarrier quality metrics, or other multi-user feedback parameters associated with each access point participating in the coordinated sounding exchange. The station 204 may transmit the channel state information 210 in a multi-user format that enables the first access point 202 and the optional second access point 702 to derive coordinated transmission parameters that mitigate inter-access point interference and align spatial streams. The structural relationship among the first access point 202, the optional second access point 702, and the station 204, each of which is configured to participate in the transmission and/or receipt of the NDPA frame 206, the NDPs 208a and 208b, and the channel state information 210, wherein the dummy station 704 is identified in the multi-user NDPA frame 206 for signaling purposes without participating in channel estimation or feedback generation, may support execution of coordinated beamforming methods described with reference to the subsequent figures.

In one or more examples, the first access point 202 and the optional second access point 702 may coordinate transmission timing and beamforming parameters based on the channel state information 210 received from the station 204. The first access point 202 and the optional second access point 702 may exchange coordination information through backhaul signaling, control channels, or predefined synchronization mechanisms to align transmission phases and spatial stream allocations. The channel state information 210 may be utilized by each participating access point to compute coordinated pre-coding weights that reduce interference at the station 204 while maintaining throughput objectives. The described configuration may enable the first access point 202 and the optional second access point 702 to perform coordinated beamforming operations under synchronization and signaling constraints defined by the IEEE 802.11 WLAN specification.

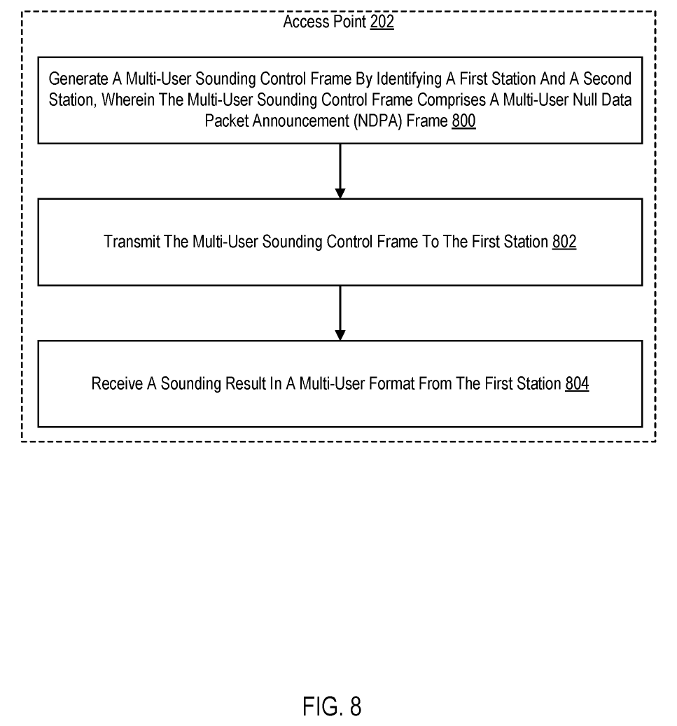

FIG. 7B therefore illustrates an example coordinated beamforming system 700b in which the first access point 202 and the optional second access point 702 may cooperate to perform a sounding exchange and to utilize the multi-user formatted channel state information 210 generated by the station 204. While FIG. 7B emphasizes the structural arrangement of multiple access points 202 and 702, the station 204, and the dummy station 704 during transmission of the NDPA frame 206 and the NDPs 208a and 208b, FIG. 8 provides a flowchart illustrating an example method that may be performed in a system similar to that of FIGS. 7A and/or 7B . FIG. 8 further depicts operational steps associated with generating a multi-user sounding control frame identifying a station and a second station and receiving a multi-user formatted sounding result in a multi-user or coordinated beamforming environment, as further described herein.

For further explanation, FIG. 8 sets forth a flowchart illustrating an example method of performing a beamforming protocol in a multi-user or coordinated beamforming environment by identifying a first station (e.g., the station 204) and a second station (e.g., the dummy station 704) in a multi-user sounding control frame in accordance with embodiments of the present disclosure. The example method of FIG. 8 can be carried out in a system similar to that of FIGS. 1, 7A and/or 7B. The method of FIG. 8 can be performed by at least one access point (e.g., the access point 202 or the optional second access point 702) of a plurality of access points configured to generate the multi-user sounding control frame identifying the first station 204 and the second station 704, transmit the multi-user sounding control frame to the first station 204, and receive a sounding result in a multi-user format from the first station 204. In one or more embodiments, the multi-user sounding control frame may comprise the multi-user NDPA frame (e.g., the NDPA frame 206), although other sounding control frame formats may be used.

The method of FIG. 8 includes generating 800, by at least one access point of a plurality of access points, a multi-user sounding control frame identifying a first station and a second station. Generating 800 the multi-user sounding control frame may be carried out by constructing the sounding control frame to include station identification fields corresponding to the first station 204 and the second station 704. In one or more examples, generating 800 the multi-user sounding control frame may include populating sounding configuration fields that specify multi-user feedback format parameters applicable to a coordinated or multi-user sounding exchange. Generating 800 the multi-user sounding control frame may further include designating the second station 704 within a station information field to satisfy a multi-user sounding control frame structure while directing channel estimation and feedback generation to the first station 204.

In some embodiments, generating 800 the multi-user sounding control frame may include assigning a predefined station identifier corresponding to the second station 704 within a station information field of the sounding control frame. For example, generating 800 the multi-user sounding control frame may include selecting a reserved association identifier or other placeholder identifier that is recognized by the access point 202 and the optional second access point 702 as not corresponding to an active station participating in channel estimation. In other embodiments, generating 800 the multi-user sounding control frame may include configuring feedback format indicators, grouping parameters, or codebook selection fields applicable to multi-user sounding while limiting the sounding exchange to the first station 204. Generation of the multi-user sounding control frame under these conditions may enable compliance with multi-user sounding format rules while directing channel estimation and feedback generation to the first station 204.

The method of FIG. 8 also includes transmitting 802, by the at least one access point, the multi-user sounding control frame to the first station. Transmitting 802 the multi-user sounding control frame may be carried out by providing the sounding control frame to transmission circuitry for wireless transmission to the first station 204. In one or more examples, transmitting 802 the multi-user sounding control frame may include scheduling the transmission within a defined transmission opportunity in accordance with medium access control timing constraints defined by the IEEE 802.11 WLAN specification. Transmitting 802 the multi-user sounding control frame may therefore enable a sounding exchange in which the first station 204 performs channel estimation and prepares a multi-user formatted sounding result while the second station 704 remains inactive for channel estimation and feedback generation.

In some embodiments, transmitting 802 the multi-user sounding control frame may include coordinating transmission of the multi-user sounding control frame among the plurality of access points participating in the sounding exchange. For example, transmitting 802 the multi-user sounding control frame may include synchronizing frame transmission timing between the first access point 202 and the optional second access point 702 to ensure consistent identification of the station 204 and the second station 704 within the sounding control frame. In other embodiments, transmitting 802 the multi-user sounding control frame may include configuring the sounding control frame such that only the first station 204 is expected to perform channel estimation and feedback generation, while the second station 704 is included solely to satisfy multi-user frame structure requirements. Transmitting 802 the multi-user sounding control frame under these conditions may enable initiation of a multi-user sounding exchange involving only the first station 204 while maintaining compliance with signaling rules applicable to multi-user or coordinated beamforming procedures.

The method of FIG. 8 also includes receiving 804, by the at least one access point, a sounding result in a multi-user format from the first station. Receiving 804 the sounding result may be carried out by detecting a feedback transmission from the first station 204 and decoding the channel state information 210 formatted in accordance with multi-user feedback parameters specified in the multi-user sounding control frame. In one or more examples, the sounding result may include the channel state information 210 corresponding to the at least one access point, where the channel state information 210 represents channel characteristics between the first station 204 and the access point 202 and/or the optional second access point 702 participating in the sounding exchange. In one or more examples, receiving 804 the sounding result may include verifying that the channel state information 210 includes multi-user format elements such as singular value information, per-subcarrier quality metrics, or defined grouping parameters corresponding to the multi-user sounding configuration. Receiving 804 the sounding result may therefore enable the access point 202 and/or the optional second access point 702 to obtain the channel state information 210 suitable for subsequent multi-user or coordinated beamforming procedures while the second station 704 remains inactive during channel estimation and feedback generation.

In some embodiments, receiving 804 the sounding result may include determining that the sounding result corresponds exclusively to the first station 204 identified in the multi-user sounding control frame and not to the second station 704. For example, receiving 804 the sounding result may include validating a station identifier field within the received channel state information 210 to confirm that the feedback originates from the first station 204. In other embodiments, receiving 804 the sounding result may include storing the channel state information 210 with an association to the plurality of access points participating in the coordinated sounding exchange to enable subsequent multi-user or coordinated beamforming procedures. Receiving 804 the sounding result under these conditions may ensure that the multi-user formatted channel state information 210 is correctly attributed to the first station 204 while preserving compliance with multi-user frame structure requirements.

The method steps of FIG. 8 collectively describe a process for generating a multi-user sounding control frame identifying a first station and a second station as well as obtaining a multi-user formatted sounding result from the first station in a multi-user or coordinated beamforming environment. Generating 800 the multi-user sounding control frame, transmitting 802 the sounding control frame to the first station, and receiving 804 the sounding result in a multi-user format cooperate to enable the at least one access point to obtain channel state information formatted in accordance with multi-user feedback parameters while satisfying multi-user sounding control frame structure requirements through identification of the second station to satisfy multi-user sounding control frame structure requirements. Through these operations, the at least one access point may initiate a multi-user sounding exchange involving only the first station and may obtain channel state information suitable for subsequent multi-user or coordinated beamforming procedures. The coordinated execution of generating 800 the multi-user sounding control frame, transmitting 802 the sounding control frame to the first station, and receiving 804 the sounding result may reduce signaling overhead associated with involving additional active stations and may improve spectral efficiency under signaling constraints defined by the IEEE 802.11 WLAN specification.

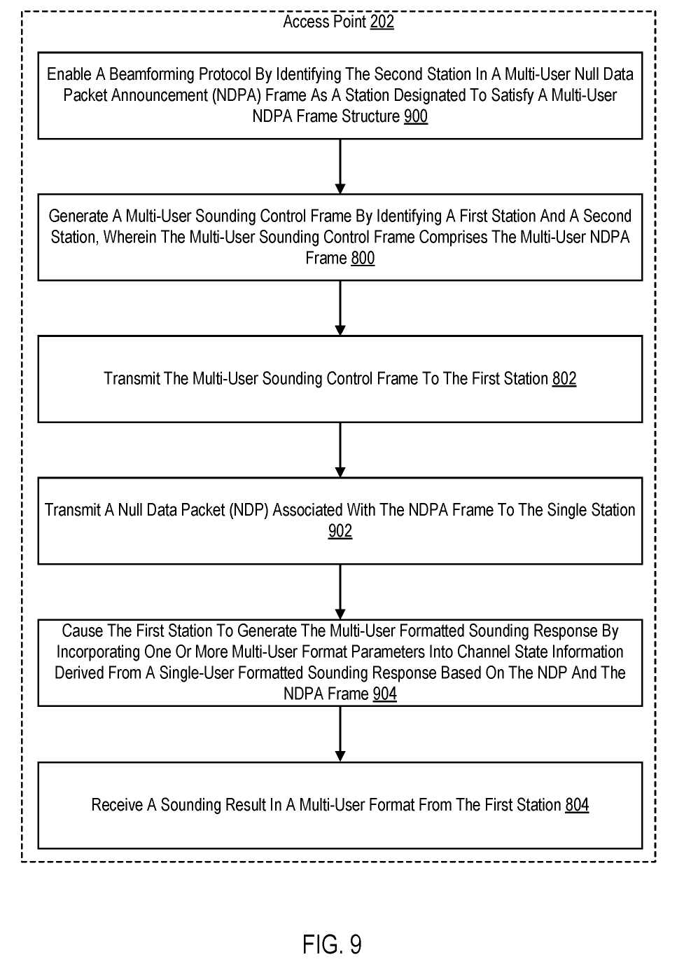

FIG. 8 therefore illustrates an example method executed by at least one access point of a plurality of access points for performing a beamforming protocol that includes identifying a second station within a multi-user sounding control frame and obtaining multi-user formatted channel state information from a first station. The sequence of operations shown in FIG. 8 demonstrates how the at least one access point may transition from generating 800 the multi-user sounding control frame to transmitting 802 the sounding control frame and subsequently receiving 804 the sounding result in a multi-user format. FIG. 9 sets forth a flowchart illustrating an example method that expands upon the operations described with reference to FIG. 8 by detailing additional operations including enabling a beamforming protocol by identifying a second station designated to satisfy a multi-user NDPA frame structure, generating and transmitting a multi-user sounding control frame comprising a multi-user NDPA frame, transmitting an NDP associated with the NDPA frame, causing generation of a multi-user formatted sounding response, and receiving the multi-user formatted sounding response as further described herein.

For further explanation, FIG. 9 sets forth a flowchart illustrating an example method of enabling a beamforming protocol in a multi-user or coordinated beamforming environment by identifying a second station (e.g., the dummy station 704) in a multi-user sounding control frame as a station designated to satisfy a multi-user NDPA frame structure, transmitting a NDP (e.g., the NDP 208a and/or 208b), causing generation of a multi-user formatted sounding response, and receiving the multi-user formatted sounding response in accordance with embodiments of the present disclosure. The example method of FIG. 9 can be carried out in a system similar to that of FIGS. 1, 7A and/or 7B. The method of FIG. 9 can be performed by at least one access point (e.g., the first access point 202 or the second access point 702) of a plurality of access points configured to generate the multi-user sounding control frame identifying a first station (e.g., the station 204) and the second station 704, transmit the multi-user sounding control frame and an associated NDP 208a and/or 208b to the first station 204, and receive a sounding result in a multi-user format from the first station 204. In one or more embodiments, the multi-user sounding control frame may comprise a multi-user NDPA frame (e.g., the NDPA frame 206) associated with the NDP 208a and/or 208b, although other sounding control frame formats may be used.

The method of FIG. 9 includes enabling 900, by at least one access point of a plurality of access points, a beamforming protocol by identifying a second station in a multi-user sounding control frame as a station designated to satisfy a multi-user sounding control frame structure. Enabling 900 the beamforming protocol may be carried out by constructing the multi-user sounding control frame to include a station information field identifying the first station 204 and a separate station information field identifying the second station 704 as the placeholder station to satisfy a multi-user NDPA frame structure. In one or more examples, enabling 900 the beamforming protocol may include assigning a predefined identifier corresponding to the second station 704 that satisfies multi-user frame structure requirements while not corresponding to an active station participating in channel estimation or feedback generation. In one or more examples, the beamforming protocol may be a multi-user beamforming protocol configured to apply multi-user beamforming signaling semantics while transmitting to the first station 204. As another example, the beamforming protocol may alternatively be a coordinated beamforming protocol configured to apply multi-user beamforming signaling semantics while coordinating transmissions from the plurality of access points to the first station 204. Enabling 900 the beamforming protocol may further include selecting multi-user sounding parameters applicable to a coordinated or multi-user beamforming procedure such that the multi-user sounding control frame complies with signaling rules defined by the IEEE 802.11 WLAN specification while limiting actual sounding participation to the first station 204.

In some embodiments, enabling 900 the beamforming protocol may include configuring the multi-user sounding control frame such that the second station 704 is identified solely to satisfy a minimum station count requirement associated with multi-user sounding procedures. For example, enabling 900 the beamforming protocol may include assigning a reserved association identifier or other predefined placeholder value to the second station 704 within the multi-user NDPA frame 206 while designating the first station 204 as the only station expected to perform channel estimation and generate a sounding result. In other embodiments, enabling 900 the beamforming protocol may include maintaining a mapping between the second station 704 and internal control logic of the at least one access point 202 to ensure that no channel state information is expected from the second station 704. Enabling 900 the beamforming protocol under these conditions may permit initiation of a multi-user or coordinated beamforming procedure involving only the single active station while maintaining compliance with multi-user frame structure requirements defined by the IEEE 802.11 WLAN specification.

In the method of FIG. 9, enabling 900 the beamforming protocol by identifying the second station 704 in the multi-user NDPA frame 206 may be followed by generating 800 the multi-user sounding control frame comprising the multi-user NDPA frame 206, and transmitting 802 the multi-user sounding control frame, as described with reference to FIG. 8, which may precede transmitting 902 the NDP 208a and/or 208b associated with the multi-user NDPA frame 206, as is further described herein. In the method of FIG. 9, generating 800 the sounding control frame and transmitting 802 the multi-user sounding control frame may be performed as described with reference to FIG. 8 such that station identification fields and multi-user feedback format parameters are established prior to transmission of the NDP 208a and/or 208b. Following the generation 800 of the multi-user sounding control frame and transmitting 802 the multi-user sounding control frame, the method of FIG. 9 may include transmitting 902 the NDP 208a and/or 208b associated with the multi-user sounding control frame to the first station 204. Performance of generating 800 the multi-user sounding control frame and transmitting 802 the multi-user sounding control frame prior to transmitting 902 the NDP 208a and/or 208b may ensure that channel estimation at the first station 204 is performed in accordance with multi-user sounding configuration parameters specified in the multi-user sounding control frame.

More specifically, transmitting 902 the NDP 208a and/or 208b to the first station 204 may be carried out by providing the NDP 208a and/or 208b to transmission circuitry of the at least one access point 202 following transmission of the multi-user sounding control frame. The NDP 208a and/or 208b may include training symbols distributed across spatial streams and subcarriers that can enable the first station 204 to estimate channel coefficients corresponding to wireless channels between the first station 204 and each participating access point 202 and/or 702. Transmitting 902 the NDP 208a and/or 208b may therefore initiate coordinated channel estimation at the first station 204 in accordance with multi-user sounding configuration parameters specified in the multi-user sounding control frame. Transmission of the NDP 208a and/or 208b may establish the basis for subsequent generation of the multi-user formatted sounding response derived from channel characteristics measured during reception of the NDP 208a and/or 208b.

In some embodiments, transmitting 902 the NDP 208a and/or 208b may include selecting a bandwidth, number of spatial streams, or modulation parameters consistent with multi-user or coordinated sounding requirements. For example, transmitting 902 the NDP 208a and/or 208b may include configuring training symbols across a predefined set of subcarriers that correspond to multi-user feedback grouping parameters supported by the first station 204 and applicable to multiple participating access points 202 and 702. In other embodiments, transmitting 902 the NDP 208a and/or 208b may include synchronizing transmission timing between the participating access points 202 and/or 702 in accordance with inter-frame spacing requirements defined by the IEEE 802.11 WLAN specification to ensure that the first station 204 performs coordinated channel estimation within a defined sounding interval. Transmission 902 of the NDP 208a and/or 208b in accordance with selected bandwidth, spatial stream configuration, and timing constraints may enable the first station 204 to derive channel measurements suitable for generation of a multi-user formatted sounding response reflective of channels associated with multiple access points.

The method of FIG. 9 also includes causing 904, by the at least one access point of the plurality of access points, the first station to generate the multi-user formatted sounding response by incorporating one or more multi-user format parameters into channel state information derived from a single-user formatted sounding response based on the NDP and the multi-user NDPA frame. Causing 904 the first station 204 to generate the multi-user formatted sounding response may be carried out by transmitting the multi-user sounding control frame and the NDP 208a and/or 208b with feedback format indicators that designate multi-user formatting applicable to coordinated beamforming procedures. In response to receipt of the multi-user NDPA frame 206 and the NDP 208a and/or 208b, the first station 204 may perform channel estimation for each participating access point 202 and/or 702 using the NDP 208a and/or 208b and may generate the channel state information 210 formatted in accordance with multi-user feedback parameters indicated in the multi-user NDPA frame 206. The first station 204 may extend a single-user formatted channel state representation by incorporating channel characteristics corresponding to each participating access point prior to transmitting the sounding result to at least one of the participating access points 202 and/or 702.

In some embodiments, the first station 204 may generate the multi-user formatted sounding response by appending singular value information, per-subcarrier signal-to-noise ratio metrics, grouping parameters, or defined feedback compression fields to base channel matrix representations derived from the NDP 208a and/or 208b corresponding to each participating access point 202 and/or 702. The first station 204 may determine inclusion of such multi-user format elements based on feedback configuration indicators contained in the multi-user sounding control frame and capability information associated with the first station 204. Generation of the multi-user formatted sounding response may therefore produce channel state information 210 suitable for multi-user or coordinated beamforming operations while originating from a sounding exchange involving only the single active station identified in the multi-user sounding control frame.

In the method of FIG. 9, the sounding result may be received 804 after causing 904 the first station 204 to generate the multi-user formatted sounding response. Following transmission of the multi-user sounding control frame, the NDP 208a and/or 208b, and after causing 904 the first station 204 to generate the multi-user formatted sounding response, the at least one access point 202 may detect a feedback transmission from the first station 204 and decode the channel state information 210 formatted in accordance with the multi-user feedback parameters. Receiving 804 the sounding result at the conclusion of causing 904 the first station 204 to generate the multi-user formatted sounding response may enable the access point 202 and/or the optional second access point 702 to obtain and process the multi-user formatted channel state information 210 generated based on channel state information derived from the single-user formatted sounding response for use in multi-user or coordinated beamforming procedures.

The method steps of FIG. 9 collectively describe a process for generating a multi-user formatted sounding response in a multi-user or coordinated beamforming environment involving a first active station and a second station. Enabling 900 a beamforming protocol by identifying the second station in a multi-user NDPA frame, generating 800 a multi-user sounding control frame identifying the first station and the second station, transmitting 802 the multi-user sounding control frame, transmitting 902 the NDP, causing 904 the first station to generate the multi-user formatted sounding response, and receiving 804 the sounding result cooperate to enable the at least one access point to obtain channel state information suitable for multi-user or coordinated beamforming operations without requiring participation of additional active stations. Through these operations, the at least one access point may establish multi-user sounding parameters, provide coordinated training symbols for channel estimation, and obtain multi-user formatted channel state information reflective of channels associated with multiple participating access points. The coordinated execution of enabling 900 the beamforming protocol, generating 800 the multi-user sounding control frame, transmitting 802 the multi-user sounding control frame, transmitting 902 the NDP, causing 904 the first station to generate the multi-user formatted sounding response, and receiving 804 the sounding result may support compliance with multi-user frame structure requirements while enabling coordinated beamforming procedures under signaling and synchronization constraints defined by the IEEE 802.11 WLAN specification.

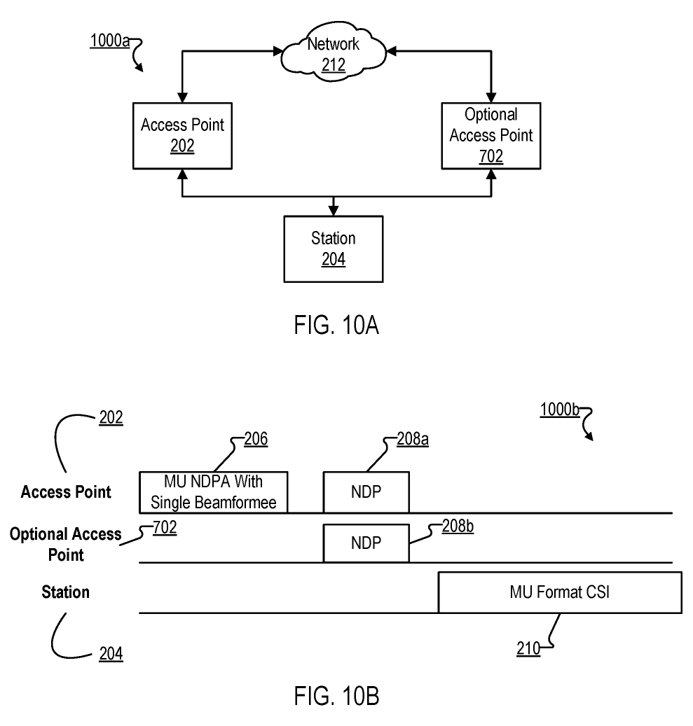

FIG. 9 therefore illustrates an example method executed by at least one access point of a plurality of access points for performing a beamforming protocol that includes enabling the beamforming protocol by identifying a second station in a multi-user NDPA frame, transmitting a multi-user sounding control frame, transmitting an associated NDP, and generating a multi-user formatted sounding response prior to receipt of channel state information. The sequence of operations shown in FIG. 9 demonstrates how the at least one access point may transition from enabling 900 the beamforming protocol to generating 800 the multi-user sounding control frame, transmitting 802 the multi-user sounding control frame, transmitting 902 the NDP, causing 904 the first station to generate the multi-user formatted sounding response, and finally receiving 804 the channel state information formatted in accordance with multi-user feedback parameters. FIG. 10A sets forth a system diagram illustrating yet another example beamforming system distinct from the system of FIG. 7A, the example beamforming system depicting a configuration including multiple access points and a single active station in a multi-user or coordinated beamforming environment, as further described herein.

In one or more embodiments, FIG. 10A illustrates an example wireless communication environment 1000a in which the computing device 100 of FIG. 1 may be deployed to perform multi-user sounding and channel state information management operations involving a single active station in accordance with embodiments of the present disclosure. The wireless communication environment 1000a may include a first access point 202, an optional second access point 702, a station 204 designated as a single active participant in a multi-user sounding exchange, and a network 212 communicatively coupling the access points 202 and 702 and the station 204 within a WLAN implemented in accordance with the IEEE 802.11 WLAN specification. In some embodiments, the computing device 100 may be implemented within the first access point 202, within the optional second access point 702, within the station 204, or within a network-based control entity coupled to the network 212 and configured to coordinate operations among multiple access points and the station 204. The computing device 100, when deployed within or communicatively coupled to the network 212, may control transmission of a multi-user NDPA frame 206 identifying only the station 204 while applying multi-user signaling semantics, coordinate transmission of one or more associated NDPs 208 by the first access point 202 and/or the optional second access point 702, and process multi-user formatted channel state information 210 generated by the station 204 for use in subsequent multi-user or coordinated beamforming operations under signaling and timing constraints governed by the IEEE 802.11 WLAN specification.

For further explanation, FIG. 10B depicts yet another example system 1000b that may be configured for performing sounding operations and receiving channel state information in a multi-user or coordinated beamforming environment in accordance with embodiments of the present disclosure. The example system 1000b may include a first access point 202 and an optional second access point 702 operating within a WLAN implemented in accordance with the IEEE 802.11 WLAN specification, where multi-user signaling semantics, inter-frame spacing requirements, and bandwidth constraints govern sounding exchanges and subsequent transmissions. In one or more examples, the first access point 202 and the optional second access point 702 may each be implemented as access points configured to participate in multi-user or coordinated beamforming procedures. The example system 1000b may further include a station 204 configured to estimate wireless channel characteristics and transmit the channel state information 210 to one or more access points. The first access point 202 and the optional second access point 702 may transmit sounding control frames, including the multi-user NDPA frame 206 and one or more NDPs 208a and 208b, to the station 204 to initiate a multi-user sounding exchange involving a single active station. The station 204 may generate the channel state information 210 in a multi-user format based on sounding configuration parameters and transmit the channel state information 210 to the first access point 202, the optional second access point 702, or both for use in multi-user or coordinated beamforming operations.

In one or more examples, the multi-user NDPA frame 206 transmitted in the system 1000b may identify only the station 204 while still applying multi-user beamforming signaling semantics. The multi-user NDPA frame 206 may include sounding configuration fields that specify multi-user feedback format parameters applicable to a multi-user or coordinated beamforming procedure. The NDPs 208a and 208b transmitted by the first access point 202 and the optional second access point 702 may include training symbols distributed across spatial streams and subcarriers to enable channel estimation at the station 204 corresponding to each participating access point. The station 204 may process the NDPs 208a and 208b using channel estimation logic and feedback encoding circuitry to generate the channel state information 210 reflective of channel characteristics between the station 204 and each participating access point while maintaining multi-user formatting semantics.

In one or more examples, the channel state information 210 generated by the station 204 may include a compressed representation of channel matrices corresponding to wireless channels between the station 204 and each of the first access point 202 and the optional second access point 702. The channel state information 210 may include pre-coding matrix information, singular value information, per-subcarrier quality metrics, or other multi-user feedback parameters associated with each participating access point. The station 204 may transmit the channel state information 210 in a multi-user format that enables the first access point 202 and the optional second access point 702 to derive transmission parameters consistent with multi-user beamforming signaling semantics while transmitting to the station 204. The structural relationship among the first access point 202, the optional second access point 702, and the station 204 may support execution of multi-user or coordinated beamforming methods described with reference to the subsequent figures.

In one or more examples, the first access point 202 and the optional second access point 702 may utilize the channel state information 210 to derive pre-coding weights and spatial stream allocations while applying multi-user beamforming signaling semantics during transmission to the station 204. The first access point 202 may initiate multi-user beamforming transmissions directed to the station 204 using multi-user formatted transmission frames even though only the station 204 participates in the data transmission. In coordinated embodiments, the first access point 202 and the optional second access point 702 may coordinate transmission timing and beamforming parameters based on the channel state information 210 to mitigate inter-access point interference while maintaining multi-user signaling semantics. The described configuration may therefore enable application of multi-user beamforming or coordinated beamforming procedures to a single active station within the WLAN environment.

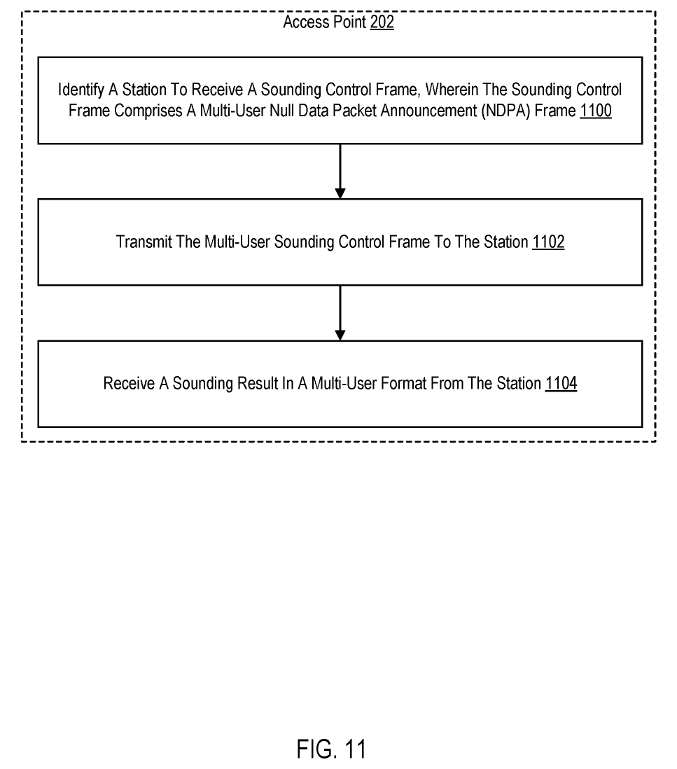

FIG. 10B therefore illustrates an example beamforming system 1000b in which multi-user NDPA signaling semantics are applied in a sounding exchange involving only a single active station 204. While FIG. 10B emphasizes the structural arrangement of the first access point 202, the optional second access point 702, and the station 204 during transmission of the multi-user NDPA frame 206 and the NDPs 208a and 208b, FIG. 11 sets forth a flowchart illustrating operational steps associated with identifying a station to receive a multi-user NDPA frame and receiving a sounding result in a multi-user format in a multi-user or coordinated beamforming environment, as further described herein.

For further explanation, FIG. 11 sets forth a flowchart illustrating an example method of performing a beamforming protocol in a multi-user or coordinated beamforming environment by identifying a station (e.g., the station 204) to receive a multi-user sounding control frame (e.g., the NDPA frame 206) in accordance with embodiments of the present disclosure. The example method of FIG. 11 can be carried out in a system similar to that of FIGS. 1, 10A and/or 10B. The method of FIG. 11 can be performed by at least one access point (e.g., the first access point 202 or the optional second access point 702) of a plurality of access points configured to identify the station 204, transmit the multi-user sounding control frame to the station 204, and receive a sounding result in a multi-user format from the station 204. In one or more embodiments, the multi-user sounding control frame may comprise a multi-user NDPA frame (e.g., the NDPA frame 206) associated with the NDP 208a and/or 208b, although other sounding control formats may be used.

The method of FIG. 11 includes identifying 1100, by at least one access point of a plurality of access points, a station to receive a multi-user sounding control frame. Identifying 1100 the station 204 may be carried out by selecting the station 204 from among one or more associated stations based on scheduling criteria, traffic demand, channel quality metrics, or capability information maintained by the access point 202 and/or the optional second access point 702. In one or more examples, identifying 1100 the station 204 may include determining that the station 204 supports multi-user feedback formatting and is eligible to participate in a multi-user or coordinated beamforming procedure. Identifying 1100 the station 204 may therefore establish the intended recipient of the multi-user sounding control frame while applying multi-user signaling semantics to a sounding exchange involving only the identified station 204.

In some embodiments, identifying 1100 the station 204 may include evaluating capability information associated with the station 204 to determine whether the station 204 supports multi-user feedback formatting. For example, identifying 1100 the station 204 may include determining that the station 204 advertises support for multi-user feedback encoding, grouping parameters, or defined codebook selection fields consistent with multi-user sounding procedures. In other embodiments, identifying 1100 the station 204 may include selecting the station 204 based on traffic scheduling priorities, quality-of-service requirements, or channel state history maintained by the access point 202 and/or the optional second access point 702. Identifying 1100 the station 204 under these conditions may enable compliance with multi-user signaling requirements while ensuring that channel estimation and feedback generation are performed by a station capable of generating a multi-user formatted sounding result.

The method of FIG. 11 also includes transmitting 1102, by the at least one access point, the multi-user sounding control frame to the identified station. Transmitting 1102 the multi-user sounding control frame may be carried out by providing the multi-user sounding control frame to transmission circuitry for wireless transmission to the station 204. In one or more examples, transmitting 1102 the multi-user sounding control frame may include scheduling the transmission within a defined transmission opportunity in accordance with medium access control timing constraints defined by the IEEE 802.11 WLAN specification. Transmitting 1102 the multi-user sounding control frame may therefore initiate a multi-user sounding exchange in which the station 204 performs channel estimation and prepares a multi-user formatted sounding result while applying multi-user signaling semantics to a sounding exchange involving only the identified station 204.

In some embodiments, transmitting 1102 the multi-user sounding control frame may include coordinating transmission of the multi-user sounding control frame among the plurality of access points participating in the sounding exchange. For example, transmitting 1102 the multi-user sounding control frame may include synchronizing frame transmission timing between the first access point 202 and the optional second access point 702 to ensure consistent identification of the station 204 within the multi-user sounding control frame. In other embodiments, transmitting 1102 the multi-user sounding control frame may include configuring the multi-user sounding control frame such that only the station 204 is expected to perform channel estimation and feedback generation while maintaining multi-user frame structure and signaling semantics. Transmitting 1102 the multi-user sounding control frame under these conditions may enable initiation of a multi-user sounding exchange involving only the station 204 while maintaining compliance with signaling rules applicable to multi-user or coordinated beamforming procedures.

The method of FIG. 11 also includes receiving 1104, by the at least one access point, a sounding result in a multi-user format from the identified station. Receiving 1104 the sounding result may be carried out by detecting a feedback transmission from the station 204 and decoding the channel state information 210 formatted in accordance with multi-user feedback parameters specified in the multi-user sounding control frame. In one or more examples, the sounding result may include the channel state information 210 corresponding to the at least one access point 202, where the channel state information 210 represents channel characteristics between the station 204 and the access point 202 and/or the optional second access point 702 participating in the sounding exchange. In one or more examples, receiving 1104 the sounding result may include verifying that the channel state information 210 includes multi-user format elements such as singular value information, per-subcarrier quality metrics, or defined grouping parameters corresponding to the multi-user sounding configuration. Receiving 1104 the sounding result may therefore enable the access point 202 and/or the optional second access point 702 to obtain the channel state information 210 suitable for subsequent multi-user or coordinated beamforming procedures.

In some embodiments, receiving 1104 the sounding result may include determining that the sounding result corresponds exclusively to the station 204 as the intended recipient of the multi-user sounding control frame. For example, receiving 1104 the sounding result may include validating a station identifier field within the received channel state information 210 to confirm that the feedback originates from the station 204. In other embodiments, receiving 1104 the sounding result may include storing the channel state information 210 with an association to the plurality of access points participating in the sounding exchange to enable subsequent multi-user or coordinated beamforming procedures. Receiving 1104 the sounding result under these conditions may ensure that the multi-user formatted channel state information 210 is correctly attributed to the station 204 while preserving compliance with multi-user signaling and frame structure requirements.

The method steps of FIG. 11 collectively describe a process for identifying a station to receive a multi-user sounding control frame and obtaining a multi-user formatted sounding result from the identified station in a multi-user or coordinated beamforming environment. Identifying 1100 the station, transmitting 1102 the multi-user sounding control frame to the identified station, and receiving 1104 the sounding result in a multi-user format cooperate to enable the at least one access point to obtain channel state information formatted in accordance with multi-user feedback parameters while applying multi-user signaling semantics to a sounding exchange involving only the single station. Through these operations, the at least one access point may initiate a multi-user sounding exchange directed to the identified station and obtain channel state information suitable for subsequent multi-user or coordinated beamforming procedures. The coordinated execution of identifying 1100 the station, transmitting 1102 the multi-user sounding control frame, and receiving 1104 the sounding result may reduce signaling overhead associated with involving additional active stations and may improve spectral efficiency under signaling constraints defined by the IEEE 802.11 WLAN specification.

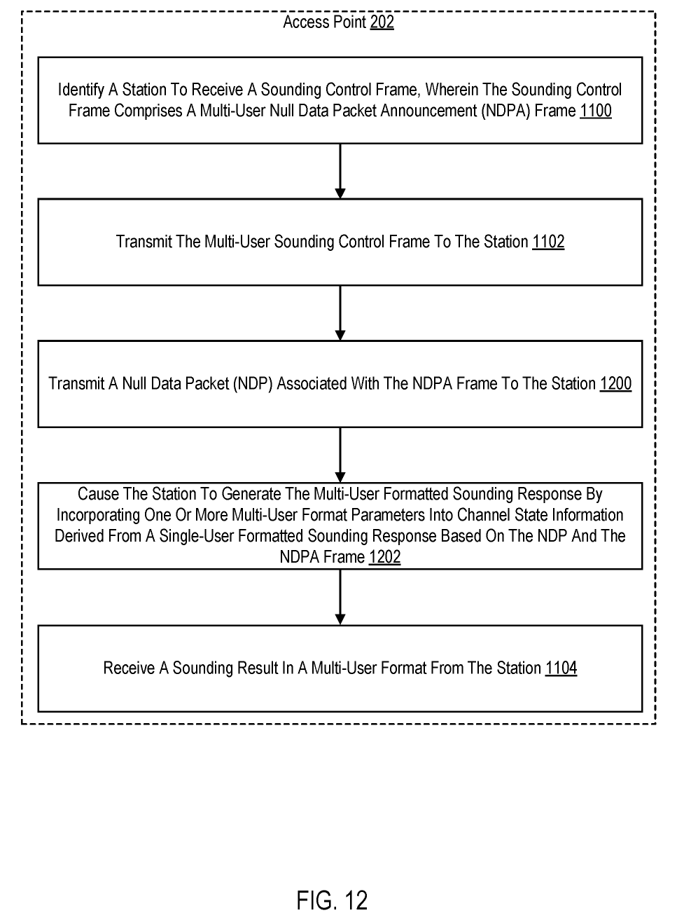

FIG. 11 therefore illustrates an example method executed by at least one access point of a plurality of access points for performing a beamforming protocol that includes identifying a station to receive a multi-user sounding control frame and obtaining multi-user formatted channel state information from the identified station. The sequence of operations shown in FIG. 11 demonstrates how the at least one access point may transition from identifying 1100 the station to transmitting 1102 the multi-user sounding control frame and subsequently receiving 1104 the sounding result in a multi-user format. FIG. 12 sets forth a flowchart illustrating an example method that expands upon the operations described with reference to FIG. 11 by detailing additional operations associated with transmission of a multi-user sounding control frame and an associated NDP to the station, as further described herein.

For further explanation, FIG. 12 sets forth a flowchart illustrating an example method of performing a beamforming protocol in a multi-user or coordinated beamforming environment including transmission of a multi-user sounding control frame comprising a NDPA frame (e.g., the NDPA frame 206) and an associated NDP (e.g., the NDP 208a and/or 208b) to a station (e.g., the station 204) in accordance with embodiments of the present disclosure. The example method of FIG. 12 can be carried out in a system similar to that of FIGS. 1, 10A and/or 10B. The method of FIG. 12 can be performed by at least one access point (e.g., the first access point 202 or the optional second access point 702) of a plurality of access points configured to generate the multi-user sounding control frame, identify the station 204, transmit the multi-user sounding control frame and an associated NDP 208a and/or 208b to the station 204, and receive a sounding result in a multi-user format from the station 204. In one or more embodiments, the multi-user sounding control frame may comprise a multi-user NDPA frame (e.g., the NDPA frame 206) associated with the NDP 208a and/or 208b, although other sounding control formats may be used.

The method of FIG. 12 discloses the performance of identifying 1100 the station 204 and transmitting 1102 the multi-user sounding control frame to the station 204 as described with reference to FIG. 11, which may precede transmitting 1200 the NDP 208 associated with the multi-user sounding control frame, as is further described herein. In the method of FIG. 12, identifying 1100 the station 204 and transmitting 1102 the multi-user sounding control frame may be performed such that station identification fields and multi-user feedback format parameters are established prior to transmission of the NDP 208a and/or 208b. Following the identification 1100 of the station 204 and transmitting 1102 the multi-user sounding control frame, the method of FIG. 12 may include transmitting 1200 the NDP 208 associated with the multi-user sounding control frame to the station 204. Performance of identifying 1100 the station 204 and transmitting 1102 the multi-user sounding control frame prior to transmitting 1200 the NDP 208a and/or 208b may ensure that channel estimation at the station 204 is performed in accordance with multi-user sounding configuration parameters specified in the multi-user sounding control frame.

More specifically, transmitting 1200 the NDP 208a and/or the NDP 208b to the station 204 may be carried out by providing the NDP 208a and/or 208b to transmission circuitry of the at least one access point 202 following transmission of the multi-user sounding control frame. The NDP 208a and/or 208b may include training symbols distributed across spatial streams and subcarriers that enable the station 204 to estimate channel coefficients corresponding to wireless channels between the station 204 and the at least one access point 202 and/or the optional second access point 702. Transmitting 1200 the NDP 208a and/or 208b may therefore initiate channel estimation at the station 204 in accordance with multi-user sounding configuration parameters specified in the multi-user sounding control frame. Transmission of the NDP 208a and/or 208b may establish the basis for subsequent generation of a multi-user formatted sounding response derived from channel characteristics measured during reception of the NDP 208a and/or 208b.

In some embodiments, transmitting 1200 the NDP 208a and/or 208b may include selecting a bandwidth, number of spatial streams, or modulation parameters consistent with multi-user or coordinated sounding requirements. For example, transmitting 1200 the NDP 208a and/or 208b may include configuring training symbols across a predefined set of subcarriers that correspond to multi-user feedback grouping parameters supported by the station 204 and applicable to one or more participating access points 202 and/or 702. In other embodiments, transmitting 1200 the NDP 208a and/or 208b may include synchronizing transmission timing among the participating access points 202 and/or 702 in accordance with inter-frame spacing requirements defined by the IEEE 802.11 WLAN specification to ensure that the station 204 performs channel estimation within a defined sounding interval. Transmission 1200 of the NDP 208a and/or 208b in accordance with selected bandwidth, spatial stream configuration, and timing constraints may enable the station 204 to derive channel measurements suitable for generation of a multi-user formatted sounding response reflective of channels associated with the participating access points.

The method of FIG. 12 also includes causing 1202, by the at least one access point of the plurality of access points, the station to generate a multi-user formatted sounding response based on the NDP and the multi-user NDPA frame. Causing 1202 the station 204 to generate the multi-user formatted sounding response may be carried out by transmitting the multi-user sounding control frame and the NDP 208a and/or 208b with feedback format indicators that designate multi-user formatting applicable to multi-user or coordinated beamforming procedures. In response to receipt of the multi-user sounding control frame and the NDP 208, the station 204 may perform channel estimation using the NDP 208 and generate the channel state information 210 formatted in accordance with multi-user feedback parameters indicated in the multi-user sounding control frame. The station 204 may incorporate one or more multi-user format parameters into channel state information derived from a single-user formatted sounding response prior to transmitting the sounding result to at least one of the participating access points 202 and/or 702.

In some embodiments, the station 204 may generate the multi-user formatted sounding response by appending singular value information, per-subcarrier signal-to-noise ratio metrics, grouping parameters, or defined feedback compression fields to a base channel matrix representation derived from the NDP 208a and/or 208b corresponding to one or more participating access points 202 and/or 702. The station 204 may determine inclusion of such multi-user format elements based on feedback configuration indicators contained in the multi-user sounding control frame and capability information associated with the station 204. Generation of the multi-user formatted sounding response may therefore produce channel state information 210 suitable for multi-user or coordinated beamforming operations while originating from a sounding exchange involving only the single active station 204 identified in the multi-user sounding control frame.

In the method of FIG. 12, the sounding result may be received 1104 after causing 1202 the station 204 to generate the multi-user formatted sounding response. Following transmission of the multi-user sounding control frame and the NDP 208a and/or 208b, and after causing 1202 the station 204 to generate the multi-user formatted sounding response, the at least one access point 202 may detect a feedback transmission from the station 204 and decode the channel state information 210 formatted in accordance with the multi-user feedback parameters. In one or more examples, the sounding result may include the channel state information 210 corresponding to the at least one access point 202, where the channel state information 210 represents channel characteristics between the station 204 and the at least one access point 202 and/or the optional second access point 702 participating in the sounding exchange. Receiving 1104 the sounding result at the conclusion of causing 1202 the station 204 to generate the multi-user formatted sounding response may enable the access point 202 and/or the optional second access point 702 to obtain and process the multi-user formatted channel state information 210 generated based on channel state information derived from the single-user formatted sounding response for use in multi-user or coordinated beamforming procedures.

The method steps of FIG. 12 collectively describe a process for transmitting a multi-user sounding control frame and an associated NDP to a station and generating a multi-user formatted sounding response in a multi-user or coordinated beamforming environment. In one or more examples, the beamforming protocol may be a multi-user beamforming protocol configured to apply multi-user beamforming signaling semantics while transmitting to the station 204. In other examples, the beamforming protocol may be a coordinated beamforming protocol configured to apply multi-user beamforming signaling semantics while coordinating transmissions from the plurality of access points 202 and/or 702 to the station 204. Identifying 1100 the station, transmitting 1102 the multi-user sounding control frame, transmitting 1200 the NDP, causing 1202 the station to generate the multi-user formatted sounding response, and receiving 1104 the sounding result cooperate to enable the at least one access point to obtain channel state information suitable for multi-user or coordinated beamforming operations without requiring participation of additional active stations. Through these operations, the at least one access point may establish multi-user sounding parameters, provide training symbols for channel estimation, and obtain multi-user formatted channel state information reflective of channels associated with one or more participating access points. The coordinated execution of identifying 1100 the station, transmitting 1102 the multi-user sounding control frame, transmitting 1200 the NDP, causing 1202 the station to generate the multi-user formatted sounding response, and receiving 1104 the sounding result may support compliance with multi-user frame structure requirements while enabling multi-user or coordinated beamforming procedures under signaling and synchronization constraints defined by the IEEE 802.11 WLAN specification.

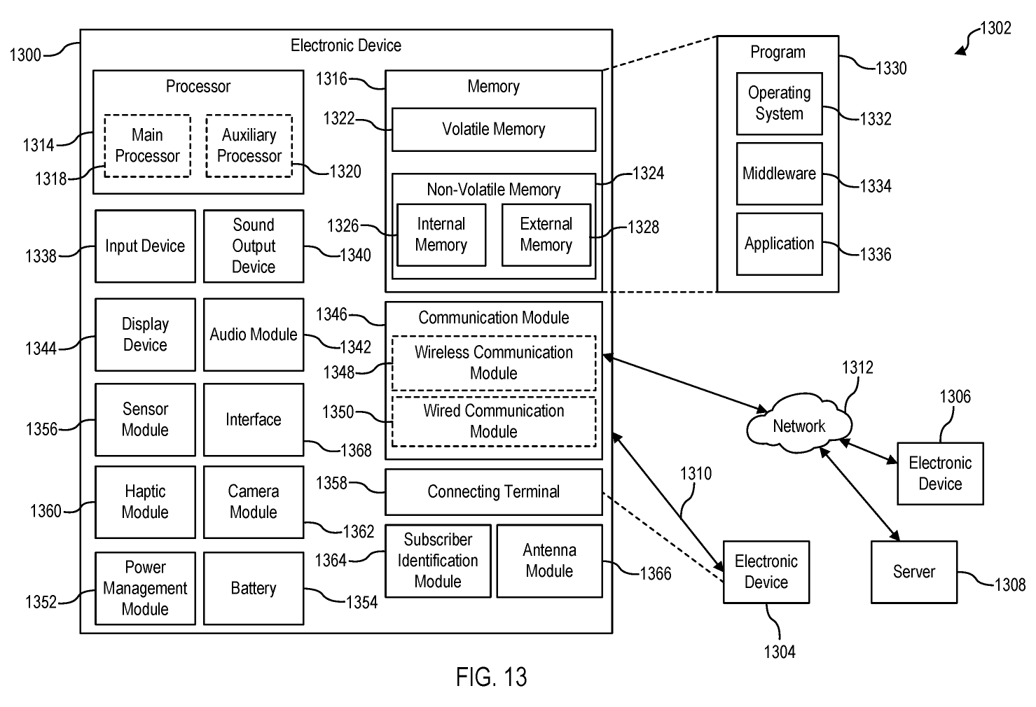

FIG. 12 therefore illustrates an example method executed by at least one access point of a plurality of access points for performing a beamforming protocol that includes transmission of a multi-user sounding control frame and an associated NDP to a station and receipt of a multi-user formatted sounding response. The sequence of operations shown in FIG. 12 demonstrates how the at least one access point may transition from identifying 1100 the station to transmitting 1102 the multi-user sounding control frame, transmitting 1200 the NDP, causing 1202 the station to generate the multi-user formatted sounding response, and finally receiving 1104 the channel state information formatted in accordance with multi-user feedback parameters. FIG. 13 sets forth an example network environment and system architecture in which an electronic device may be deployed across local, distributed, or cloud-based infrastructure to perform the beamforming methods described herein in accordance with embodiments of the present disclosure.

FIG. 13 is a block diagram of an electronic device 1300 in a network environment 1302 in accordance with embodiments of the present disclosure. The electronic device 1300 may operate independently or in conjunction with one or more other electronic devices 1304 or 1306, such as access points or stations, and one or more servers 1308 through a first network 1310 (e.g., a local or short-range communication network) or a second network 1312 (e.g., a wide-area or long-range communication network). The electronic device 1300 may correspond to, or include, the functional components of the computing device 100 described with reference to FIG. 1 and may support coordination among the access points and stations described herein. For example, the electronic device 1300 may execute one or more functionalities associated with sounding coordination, multi-user sounding control configuration, channel state information aggregation, and beamforming control to perform one or more operations associated with re-use of multi-user formatted sounding results, including the method steps described with reference to FIGS. 3-6, 8, 9, 11, and 12.

Referring to FIG. 13, the components of the electronic device 1300 illustrated therein will now be described in additional detail. These components may collectively enable the electronic device 1300 to execute the systems and methods associated with sounding coordination, multi-user sounding control configuration, channel state information processing, and re-use of multi-user formatted sounding results described throughout this disclosure. While particular components are shown in FIG. 13, additional or alternative components may be included in other embodiments, and the described components may be implemented as discrete hardware modules, integrated circuits, firmware elements, software modules, or combinations thereof.

A processor 1314 may control overall operation of the electronic device 1300 and execute instructions stored in a memory 1316 to perform sounding coordination and beamforming control operations. The processor 1314 may include a main processor 1318 and an auxiliary processor 1320 that can operate independently or cooperatively to manage computational and communication tasks associated with multi-user NDPA generation, NDP transmission control, channel state information decoding, re-use eligibility determination, and beamforming parameter computation. The main processor 1318 may execute high-level operations associated with identifying a station, transmitting a multi-user sounding control frame, transmitting an associated NDP, causing generation of a multi-user formatted sounding response, and receiving channel state information for subsequent beamforming procedures. The auxiliary processor 1320 may perform specialized functions, such as decoding multi-user formatted feedback fields, validating station identifiers, aggregating channel state information from multiple access points, or evaluating re-use thresholds associated with initiating beamforming protocols. In some embodiments, the auxiliary processor 1320 may remain active while the main processor 1318 operates in a reduced-power state, maintaining coordination signaling and processing channel state information across successive sounding exchanges.

The memory 1316 may include both volatile memory 1322 and non-volatile memory 1324 configured to store data and instructions used by the processor 1314 during operation of the electronic device 1300. The non-volatile memory 1324 may include internal memory 1326 and external memory 1328 that may store persistent datasets, software modules, and configuration parameters used for multi-user sounding control configuration, NDP transmission control, channel state information processing, and beamforming parameter derivation. The memory 1316 may also store a program 1330 that may include an operating system 1332, middleware 1334, and one or more applications 1336 executed by the processor 1314 to perform operations associated with identifying a station, transmitting a multi-user sounding control frame, transmitting an associated NDP, causing generation of a multi-user formatted sounding response, receiving channel state information, and initiating beamforming procedures based on re-use of the received sounding result. In some embodiments, the memory 1316 may also maintain historical channel state information records, capability information associated with stations, coordination parameters associated with multiple access points, and re-use validity intervals used to support real-time sounding and beamforming operations in dynamic WLAN environments.

An input device 1338 may receive user input, control parameters, or configuration data during operation of the electronic device 1300. The input device 1338 may include a touchscreen, keyboard, mouse, keypad, or other interface mechanisms that allow a user or system administrator to configure sounding parameters, select multi-user or coordinated beamforming modes, adjust feedback format indicators within a multi-user sounding control frame, or define re-use thresholds associated with previously obtained channel state information. In some embodiments, the input device 1338 may also provide interfaces for selecting stations to participate in sounding exchanges, enabling or disabling dummy station designation, or initiating diagnostic operations associated with transmission of sounding control frames and NDPs. The input device 1338 may further support firmware-level inputs that define operational tolerances, timing constraints, or synchronization parameters used during multi-user sounding and coordinated beamforming procedures.

A sound output device 1340 may output audio signals generated by the electronic device 1300. The sound output device 1340 may include one or more speakers, receivers, or other audio transducers configured to provide system notifications, alerts, or operational feedback during sounding and beamforming operations. In some embodiments, the sound output device 1340 may emit alerts indicating sounding-status changes, such as transmission of a multi-user sounding control frame, detection of a received multi-user formatted sounding result, expiration of a channel state information validity interval, or initiation of a multi-user or coordinated beamforming procedure. The sound output device 1340 may operate in conjunction with an audio module 1342 to enable audio-based diagnostics or alerting in wireless communication environments. For example, during extended beamforming operation, the audio module 1342 may produce distinct tones or voice prompts corresponding to different processing stages, such as transmission of a NDP, decoding of channel state information, or application of pre-coding weights, allowing operators to monitor performance of the electronic device 1300 without reliance on a visual indicator.

A display device 1344 may visually present information generated by the processor 1314 to a user of the electronic device 1300. The display device 1344 may include a flat-panel display, touchscreen, or projection-based display configured to render graphical interfaces and data visualizations related to sounding exchanges and beamforming operations. In some embodiments, the display device 1344 may present real-time status of transmitted multi-user sounding control frames, NDP transmissions, and received multi-user formatted sounding results, as well as decoded channel state information values associated with one or more stations. The display device 1344 may further provide dashboards depicting channel quality metrics, spatial stream allocations, pre-coding weight selections, coordination status among multiple access points, or validity intervals associated with re-use of previously obtained channel state information.

A communication module 1346 may enable the electronic device 1300 to transmit and receive data through the first network 1310 or the second network 1312. The communication module 1346 may include a wireless communication module 1348 and a wired communication module 1350, which may operate independently or cooperatively to support real-time transmission of multi-user sounding control frames, NDPs, beamformed data frames, and receipt of multi-user formatted sounding results and channel state information. In one or more embodiments, the communication module 1346 may exchange sounding configuration parameters, channel state information records, coordination data, or beamforming control signals with the other electronic devices 1304, 1306, or with the server 1308 to support distributed beamforming coordination, centralized channel state information aggregation, or cloud-assisted management of multi-user and coordinated beamforming procedures.

A power management module 1352 may regulate power distribution and consumption among the components of the electronic device 1300. The power management module 1352 may monitor voltage and current supplied to the processor 1314, the memory 1316, the communication module 1346, and other subsystems to ensure stable operation during sounding exchanges, channel state information processing, and beamforming control operations. A battery 1354 may provide electrical power to one or more of these components and may maintain continuous operation of the electronic device 1300 during mobile, edge, or remote deployments within the network environment 1302. In some embodiments, the battery 1354 may preserve sounding configuration parameters, stored multi-user formatted channel state information, coordination state among participating access points, and re-use validity intervals during temporary power interruptions to support seamless continuation of multi-user or coordinated beamforming procedures.

A sensor module 1356 may detect operational, environmental, or performance-related conditions within the electronic device 1300 and generate corresponding data signals for processing by the processor 1314. The sensor module 1356 may include temperature sensors, motion or orientation sensors, RF quality monitors, or signal strength indicators that influence sounding configuration parameters, transmission timing, feedback validation thresholds, or beamforming control sensitivity. In some embodiments, the sensor module 1356 may monitor thermal conditions or oscillator stability that affect radio frequency performance, enabling dynamic adaptation of NDPA configuration, NDP transmission parameters, or channel state information re-use criteria. The sensor module 1356 may further track link-quality metrics or interference levels within the network environment 1302 to support adaptive adjustment of multi-user or coordinated beamforming operations.

A connecting terminal 1358 may include one or more physical connectors that enable the electronic device 1300 to interface with external systems or peripheral devices. The connecting terminal 1358 may support high-speed data transfer standards such as Universal Serial Bus (USB), Peripheral Component Interconnect Express (PCIe), Ethernet, or serial interfaces to facilitate exchange of sounding configuration data, channel state information records, beamforming parameter sets, or diagnostic information. In some embodiments, the connecting terminal 1358 may support debugging, provisioning, or calibration tools used to verify NDPA configuration, NDP transmission timing, feedback decoding accuracy, or coordinated beamforming synchronization among participating access points.

A haptic module 1360 may provide tactile feedback to a user of the electronic device 1300 during operation. For example, the haptic module 1360 may generate vibrational feedback when the device initiates a sounding exchange, successfully receives a multi-user formatted sounding result, detects that previously obtained channel state information remains valid for re-use, or completes configuration of a multi-user or coordinated beamforming transmission. In some embodiments, the haptic module 1360 may provide distinct tactile patterns corresponding to different operational states, such as initiation of a multi-user sounding control transmission, detection of feedback decoding errors, or successful synchronization among multiple access points in a coordinated beamforming procedure.

A camera module 1362 may capture still images or video for diagnostics, environmental awareness, or device state verification. In some embodiments, the camera module 1362 may capture visual indicators associated with antenna alignment, physical installation conditions, or environmental factors that may affect wireless channel characteristics and beamforming performance. The camera module 1362 may provide captured image or video data to the processor 1314 or the communication module 1346 for diagnostic analysis, remote monitoring, or maintenance operations related to sounding and beamforming functionality.

A subscriber identification module 1364 may store authentication credentials, device identifiers, or security keys used by the communication module 1346 to access secured wireless networks, enterprise infrastructure, or cloud-based coordination services. An antenna module 1366 may enable wireless transmission and reception of signals, including IEEE 802.11 WLAN signals used for sounding exchanges, multi-user sounding control transmission, NDP transmission, and receipt of multi-user formatted channel state information. An interface 1368 may support communication and data exchange between the electronic device 1300 and external peripherals, network equipment, diagnostic systems, or distributed control entities involved in multi-user or coordinated beamforming operations.

FIG. 13 therefore illustrates an example electronic device 1300 and network environment 1302 that can implement the systems and methods for managing sounding exchanges and re-use of multi-user formatted channel state information described with reference to FIGS. 3-6, 8, 9, and 12. The arrangement of components shown in FIG. 13 provides a hardware and network foundation for carrying out any of the method steps described herein, including generation and transmission of multi-user sounding control frames, transmission of associated NDPs, receipt and processing of multi-user formatted sounding results, and initiation of multi-user or coordinated beamforming procedures based on re-use of previously obtained channel state information.

The systems, architectures, and methods described herein collectively provide a wireless communication framework that enables use and, in some embodiments, re-use of multi-user formatted sounding results within single-user, multi-user, and coordinated beamforming deployments. The described embodiments illustrate how one or more access points and stations can cooperate through transmission of multi-user sounding control frames, associated NDPs, and generation of multi-user formatted channel state information to support consistent signaling semantics across different beamforming modes. By identifying a station for participation in a multi-user sounding exchange and, in some embodiments, designating a dummy station to satisfy multi-user frame structure requirements, the disclosed techniques may reduce signaling overhead, limit repeated sounding exchanges, and improve spectral efficiency under IEEE 802.11 constraints. The coordinated interaction among the computing device, one or more access points, one or more stations, and associated network infrastructure may further enable efficient aggregation, validation, storage, and re-use of channel state information across transmission intervals, thereby enhancing throughput, flexibility, and interoperability in next-generation WLAN environments. While specific configurations, signaling sequences, and architectural arrangements have been described with reference to the accompanying figures, variations in network topology, device implementation, signaling parameters, and control logic may be implemented to achieve similar operational and performance benefits consistent with the embodiments of the present disclosure.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for performing a beamforming protocol, the method comprising:
transmitting, from an access point, a sounding control frame to a station; and
receiving, at the access point and based on one or more sounding capabilities of the station, a sounding result in a multi-user format from the station.

2. The method of claim 1, wherein the sounding control frame comprises a null data packet announcement (NDPA) frame, the method further comprising:
generating, by the access point, the NDPA frame comprising an indicator requesting the station return the sounding result in the multi-user format to the access point.

3. The method of claim 2, further comprising:
transmitting, from the access point, a null data packet (NDP) to the station, wherein the NDP is associated with the NDPA frame.

4. The method of claim 3, further comprising:
causing, by the access point, the station to generate a multi-user formatted sounding response by incorporating one or more multi-user format parameters into channel state information derived from a single-user formatted sounding response based on the NDP and the NDPA frame.

5. The method of claim 1, wherein the sounding result includes channel state information corresponding to the access point.

6. The method of claim 1, further comprising:
performing, by the access point, a multi-user beamforming protocol based on the sounding result.

7. The method of claim 1, further comprising:
performing, by the access point, a coordinated beamforming protocol based on the sounding result.

8. A method for performing a beamforming protocol, the method comprising:
generating, by at least one access point of a plurality of access points, a multi-user sounding control frame identifying a first station and a second station;
transmitting, by the at least one access point, the multi-user sounding control frame to the first station; and
receiving, by the at least one access point, a sounding result in a multi-user format from the first station.

9. The method of claim 8, wherein the multi-user sounding control frame comprises a multi-user null data packet announcement (NDPA) frame, the method further comprising:
enabling, by the at least one access point, the beamforming protocol by identifying the second station in the multi-user NDPA frame as a station designated to satisfy a multi-user NDPA frame structure.

10. The method of claim 9, further comprising:
transmitting, by the at least one access point, a null data packet (NDP) associated with the multi-user NDPA frame to the first station.

11. The method of claim 10, further comprising:
causing, by the at least one access point, the first station to generate a multi-user formatted sounding response by incorporating one or more multi-user format parameters into channel state information derived from a single-user formatted sounding response based on the NDP and the multi-user NDPA frame.

12. The method of claim 8, wherein the sounding result includes channel state information corresponding to the at least one access point.

13. The method of claim 8, wherein the beamforming protocol is a multi-user beamforming protocol configured to apply multi-user beamforming signaling semantics while transmitting to the first station.

14. The method of claim 8, wherein the beamforming protocol is a coordinated beamforming protocol configured to apply multi-user beamforming signaling semantics while coordinating transmissions from the plurality of access points to the first station.

15. A method for performing a beamforming protocol, the method comprising:
identifying, by at least one access point of a plurality of access points, a station to receive a multi-user sounding control frame;
transmitting, by the at least one access point, the multi-user sounding control frame to the station; and
receiving, by the at least one access point, a sounding result in a multi-user format from the station.

16. The method of claim 15, wherein the multi-user sounding control frame comprises a multi-user null data packet announcement (NDPA), the method further comprising:
transmitting, by the at least one access point, a null data packet (NDP) associated with the multi-user NDPA frame to the station.

17. The method of claim 16, further comprising:
causing, by the at least one access point, the station to generate a multi-user formatted sounding response by incorporating one or more multi-user format parameters into channel state information derived from a single-user formatted sounding response based on the NDP and the multi-user NDPA frame.

18. The method of claim 15, wherein the sounding result includes channel state information corresponding to the at least one access point.

19. The method of claim 15, wherein the beamforming protocol is a multi-user beamforming protocol configured to apply multi-user beamforming signaling semantics while transmitting to the station.

20. The method of claim 15, wherein the beamforming protocol is a coordinated beamforming protocol configured to apply multi-user beamforming signaling semantics while coordinating transmissions from the plurality of access points to the station.
